(19) United States
(12) Patent Application Publication
(10) Pub. No.: US 2014/0232076 A1
(43) Pub. Date: Aug. 21, 2014

(54) CONVERTIBLE LUGGAGE AND LUGGAGE CART ASSEMBLY

(71) Applicant: American Recreation Products, LLC., Boulder, CO (US)

(72) Inventors: Andrew Day, Lafayette, CO (US); Chase Schofield, Boulder, CO (US)

(21) Appl. No.: 14/182,641

(22) Filed: Feb. 18, 2014

Related U.S. Application Data
(60) Provisional application No. 61/766,310, filed on Feb. 19, 2013.

(51) Int. Cl. B62B 1/12

(52) U.S. Cl. CPC B62B 1/125
USPC 280/37

(57) ABSTRACT

A luggage and luggage cart assembly includes a piece of luggage selectively moveable between a collapsed configuration and an expanded configuration. The luggage has a greater longitudinal length in the expanded configuration as compared to the collapsed configuration. A cart is selectively moveable between a retracted position and an extended position. The cart, in the retracted position, is sized and arranged to carry the luggage in the collapsed configuration and, in the extended position, is sized and arranged to carry the luggage in the expanded configuration. The luggage is selectively attachable and detectable from the cart. With the luggage in the collapsed configuration and the cart in the retracted position, the luggage and cart collectively have a maximum size less than or equal to 45 linear inches so that the assembly can be carried onto an aircraft.

### CROSS-REFERENCE TO RELATED APPLICATION

This application is a non-provisional application and claims priority to U.S. Provisional Patent Application Ser. No. 61/766,310 filed Feb. 19, 2013, which is hereby incorporated by reference in its entirety.

### BACKGROUND

The field of the invention relates generally to luggage and luggage cart assemblies and more particularly to convertible luggage and luggage cart assemblies.

### SUMMARY

In one aspect, a luggage and luggage cart assembly generally comprises a piece of luggage selectively moveable between a collapsed configuration and an expanded configuration. The luggage has a greater longitudinal length in the expanded configuration as compared to the collapsed configuration. A cart is selectively moveable between a retracted position and an extended position. The cart, in the retracted position, is sized and arranged to carry the luggage in the collapsed configuration and, in the extended position, is sized and arranged to carry the luggage in the expanded configuration.

In another aspect, a luggage and luggage cart assembly generally comprises a cart and a packbag selectively attachable and detachable from the cart. The packbag has a pair shoulder strap for carrying the packbag alone when the packbag is detached from the cart and the assembly when the packbag is attached to the cart in a generally vertical orientation.

In a further aspect, a luggage and luggage cart assembly generally comprises a cart and a piece of luggage selectively attachable and detectable from the cart. The luggage and cart is sized and configured to be carried onto an aircraft when the luggage is attached to the cart. The luggage and cart collectively have a maximum size less than or equal to 45 linear inches.

### BRIEF DESCRIPTION OF THE DRAWINGS

FIGS. 1-16 show one suitable embodiment of a convertible luggage and luggage cart assembly comprising a piece of luggage and a cart.

FIGS. 17-23 show the luggage cart of the convertible luggage and luggage cart assembly of FIGS. 1-16 with the luggage removed.

FIGS. 24-31 show the assembly having a different piece of luggage than the one seen in FIGS. 1-16.

FIGS. 32-38 show the assembly having yet a different piece of luggage than the one seen in FIGS. 1-16 and FIG. 24-31.

FIG. 39 illustrates the cart of the assembly being used to transport the luggage seen FIGS. 1-16 and the luggage seen FIGS. 32-38 simultaneously.

FIGS. 40-46 are detailed drawings of the luggage cart illustrated in FIGS. 17-23.

### DETAILED DESCRIPTION OF THE DRAWINGS

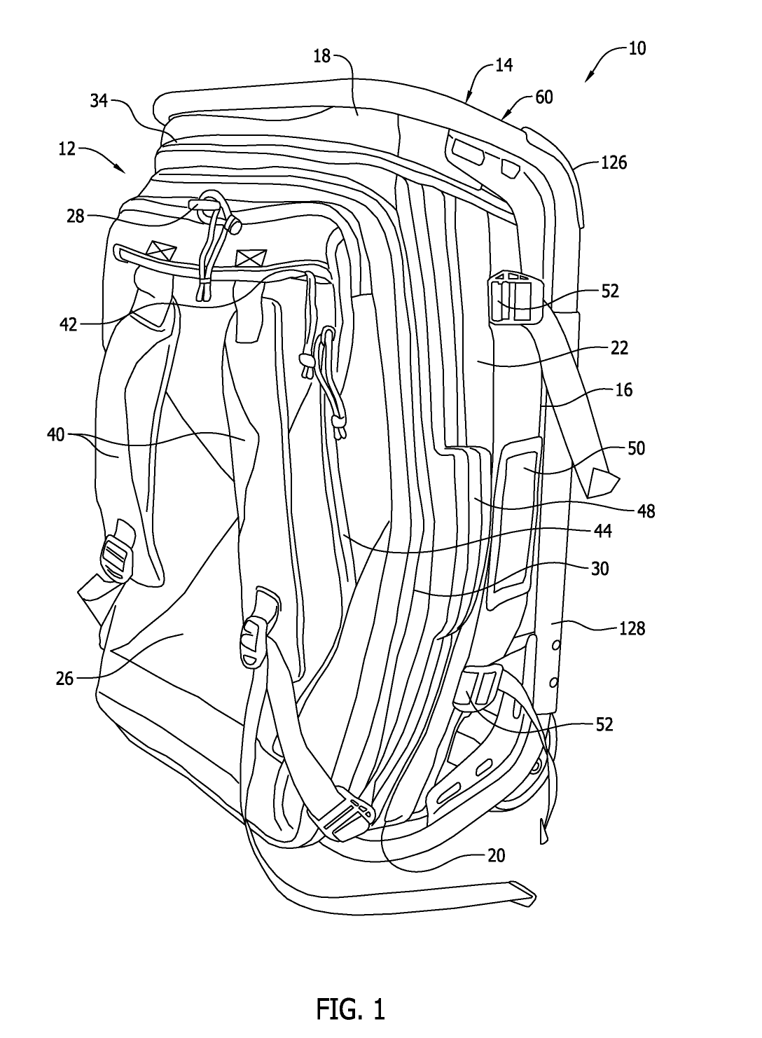

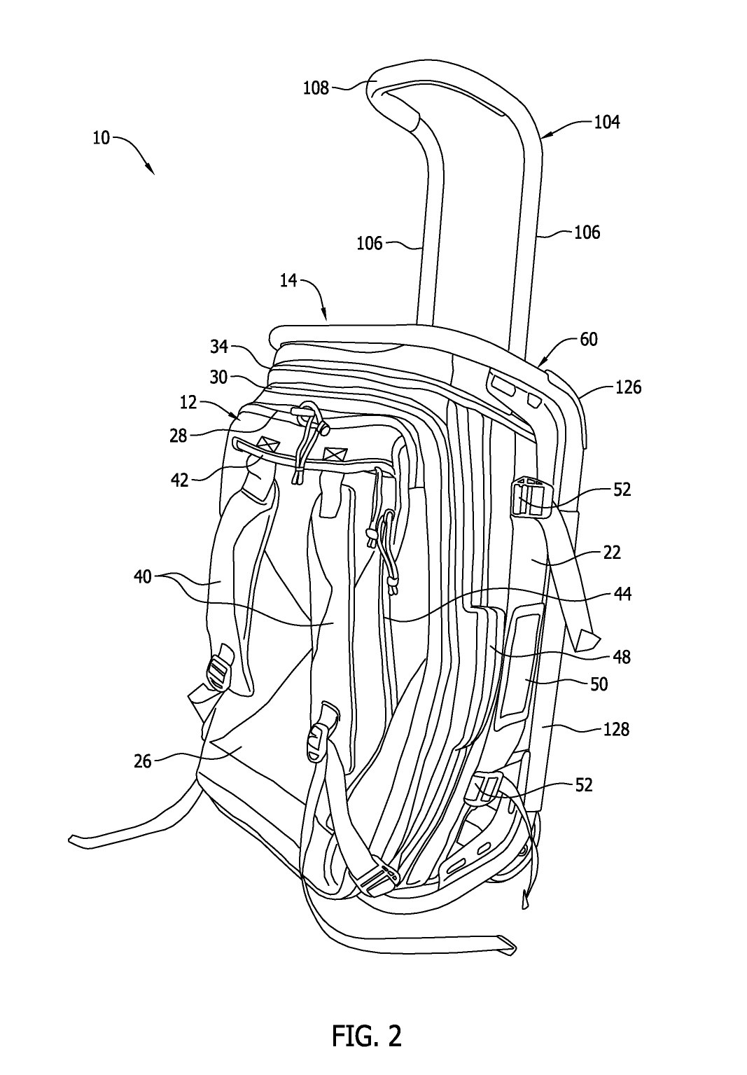

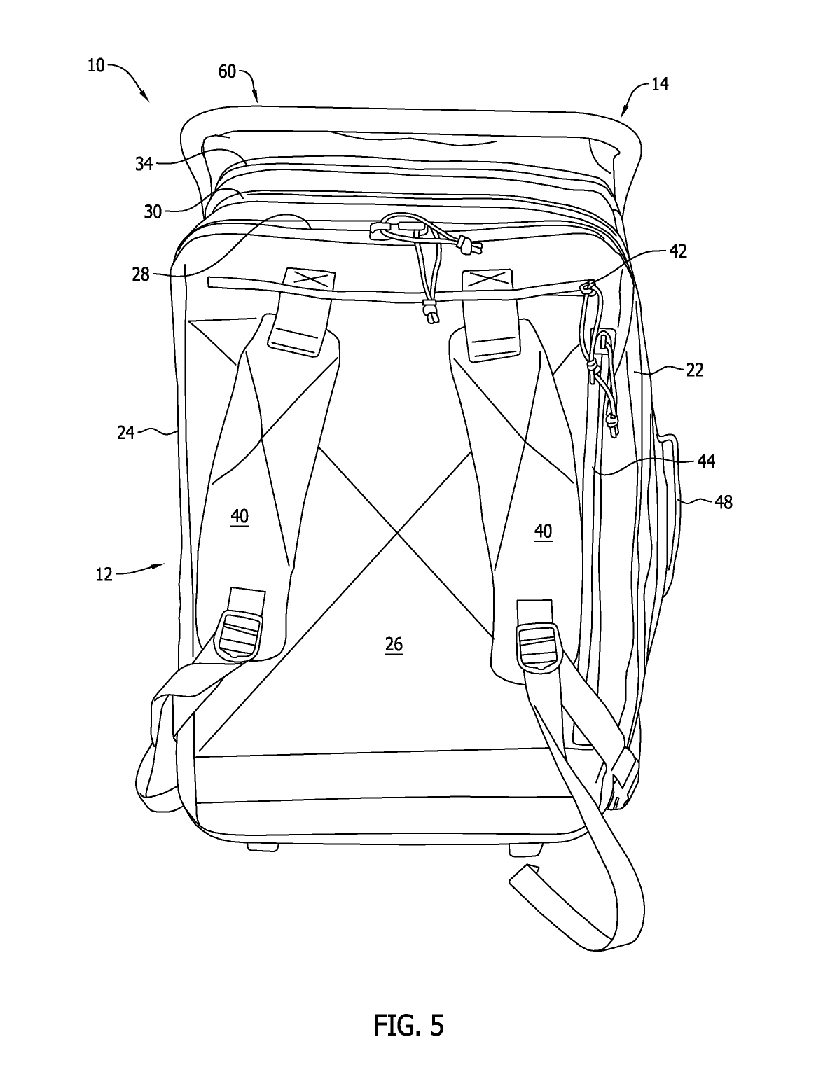

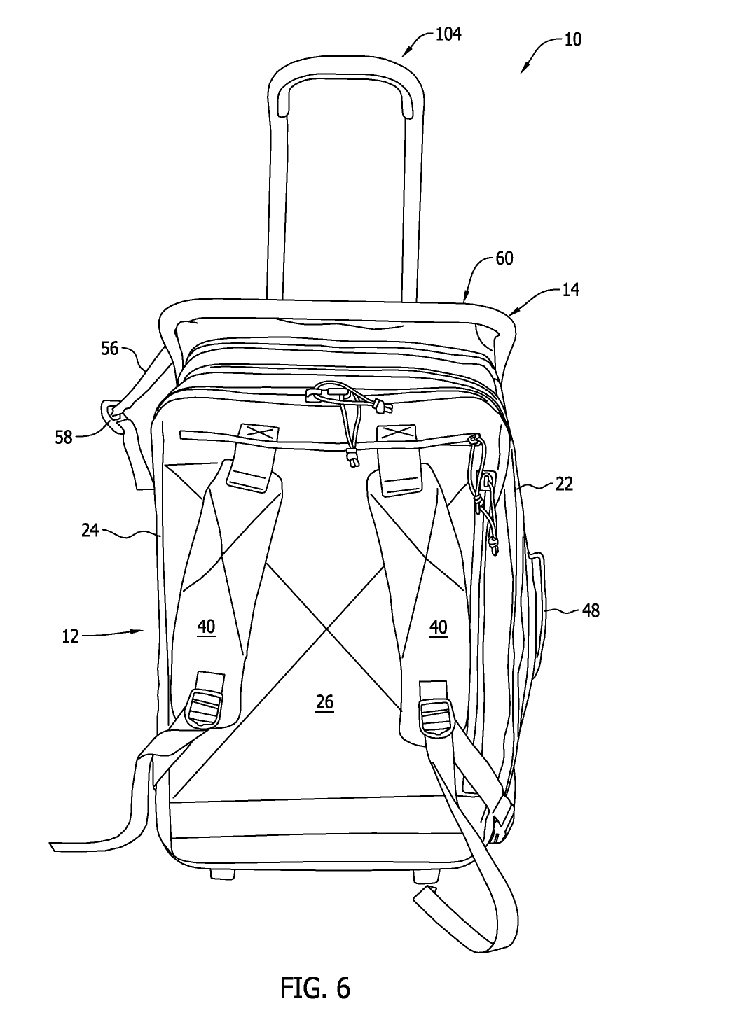

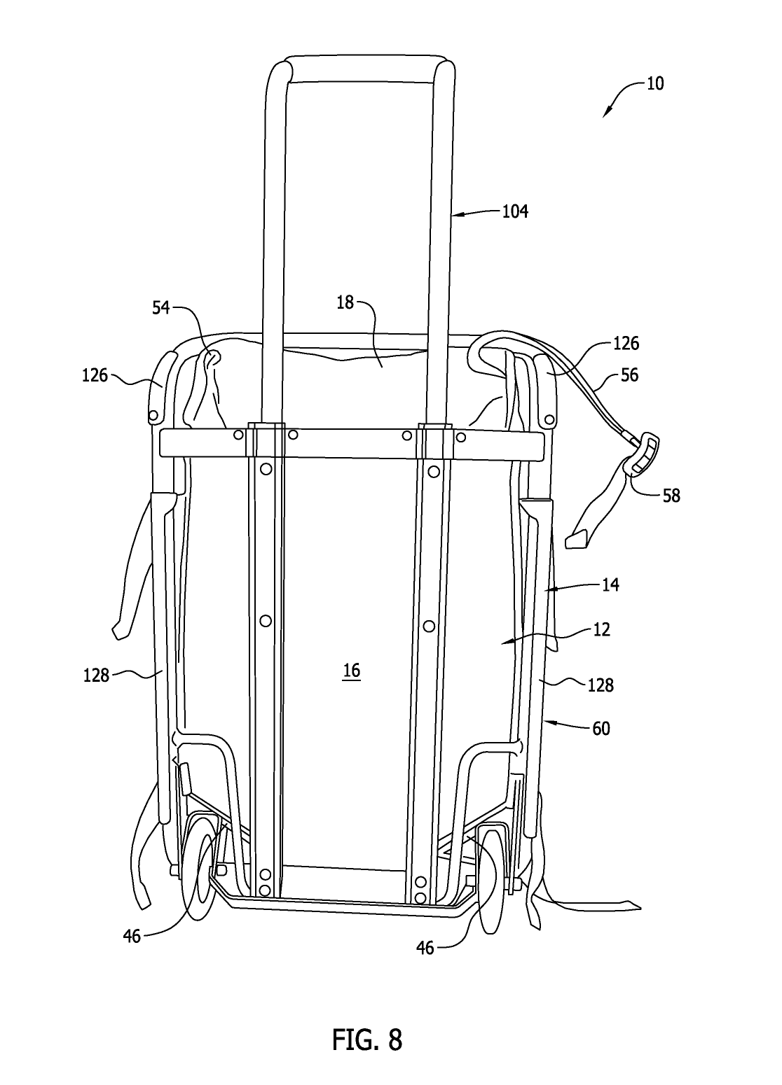

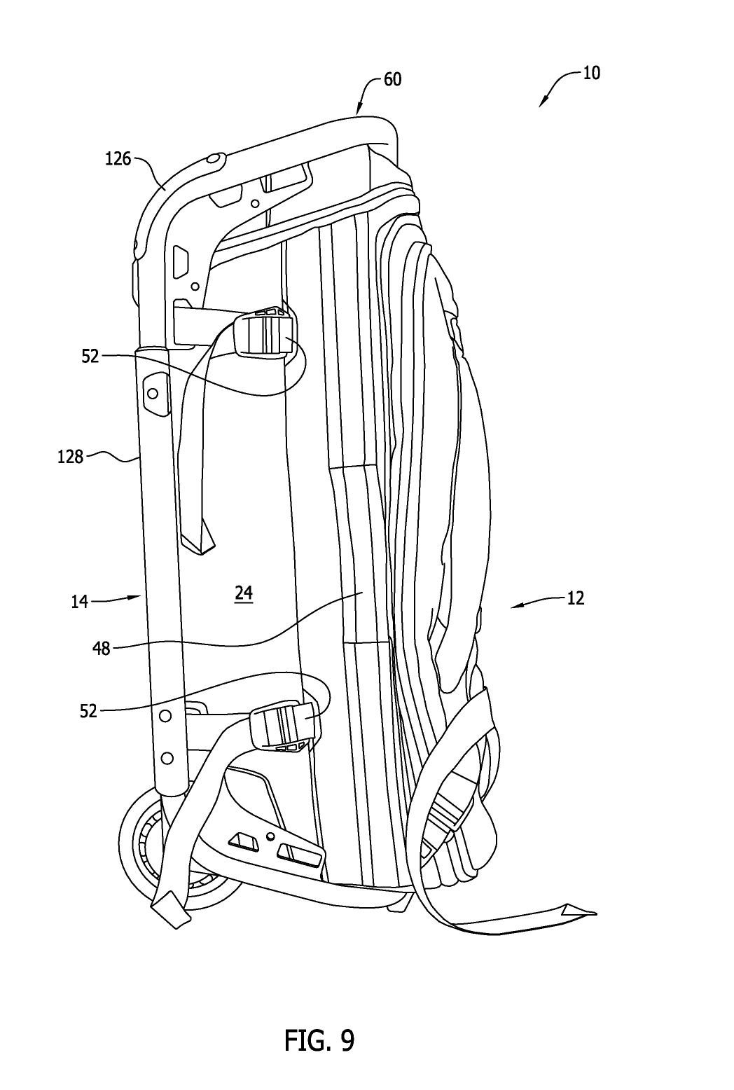

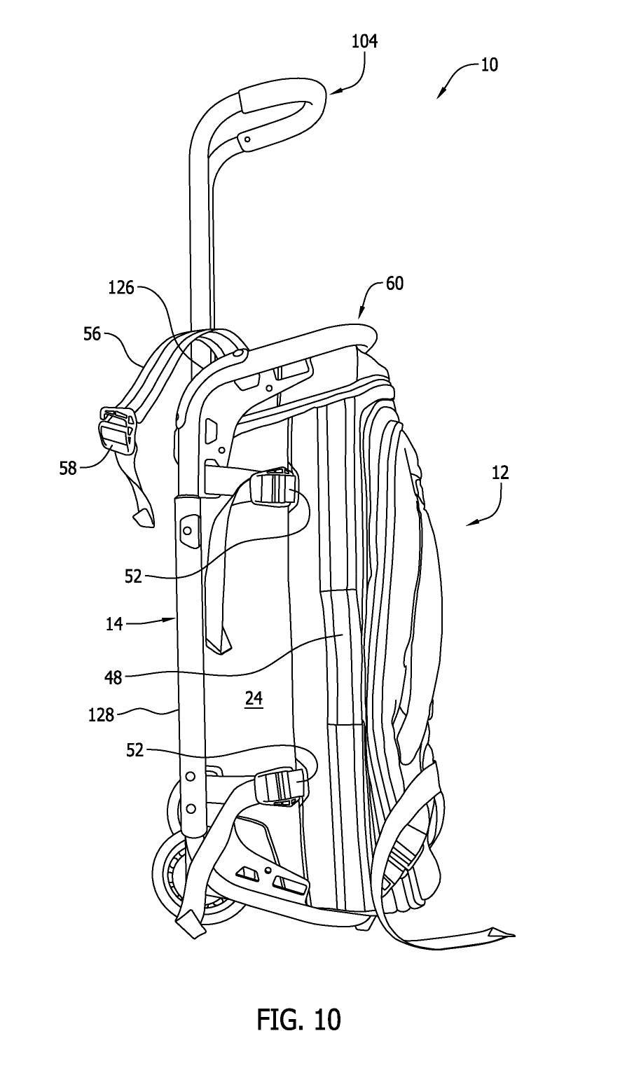

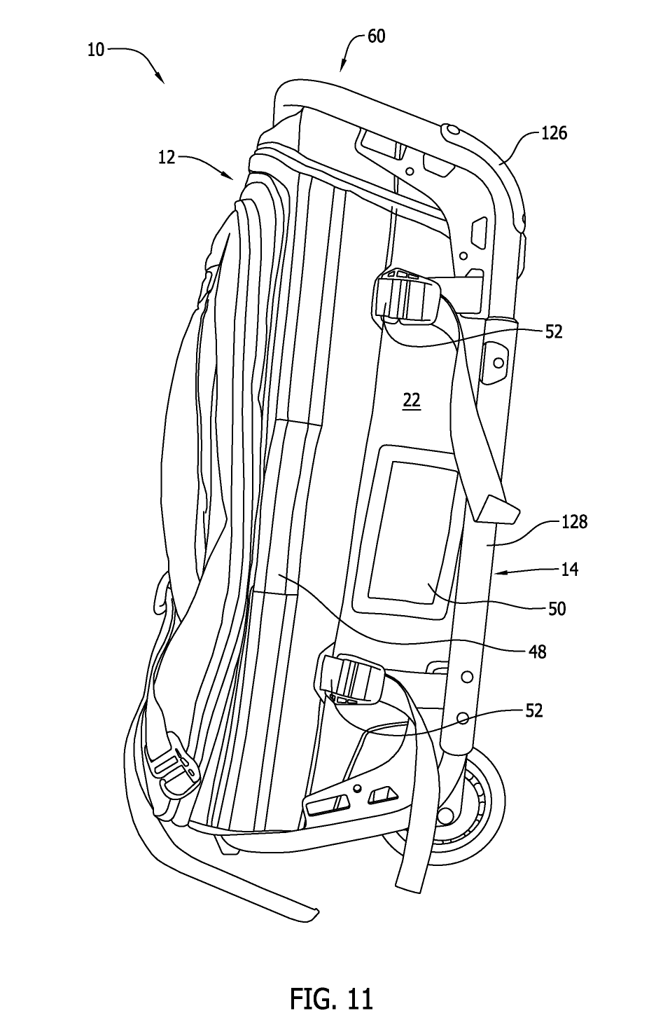

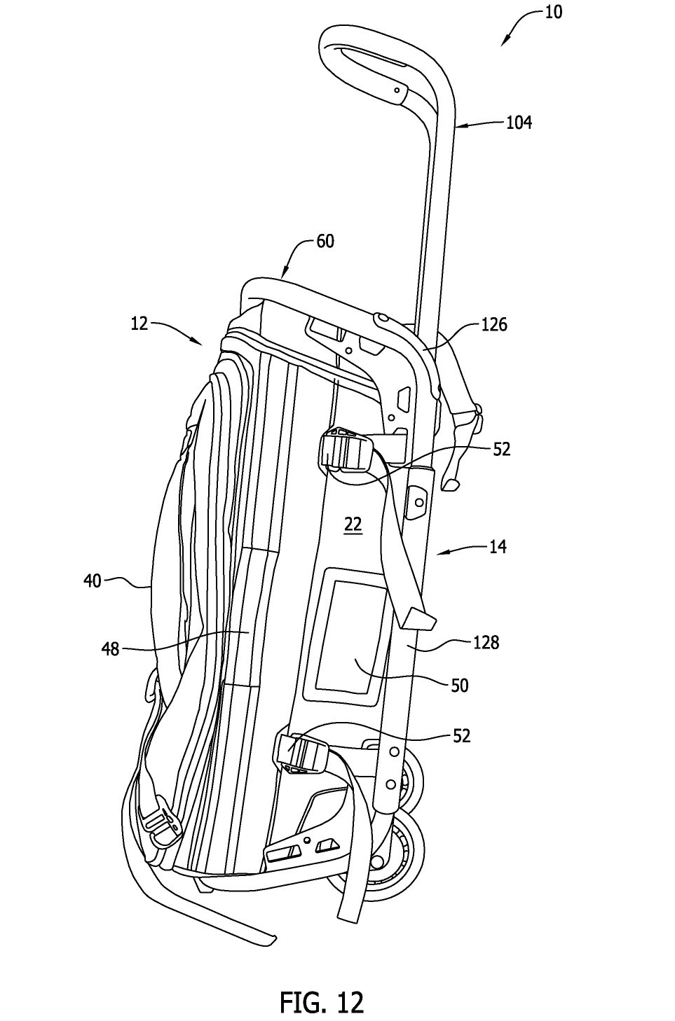

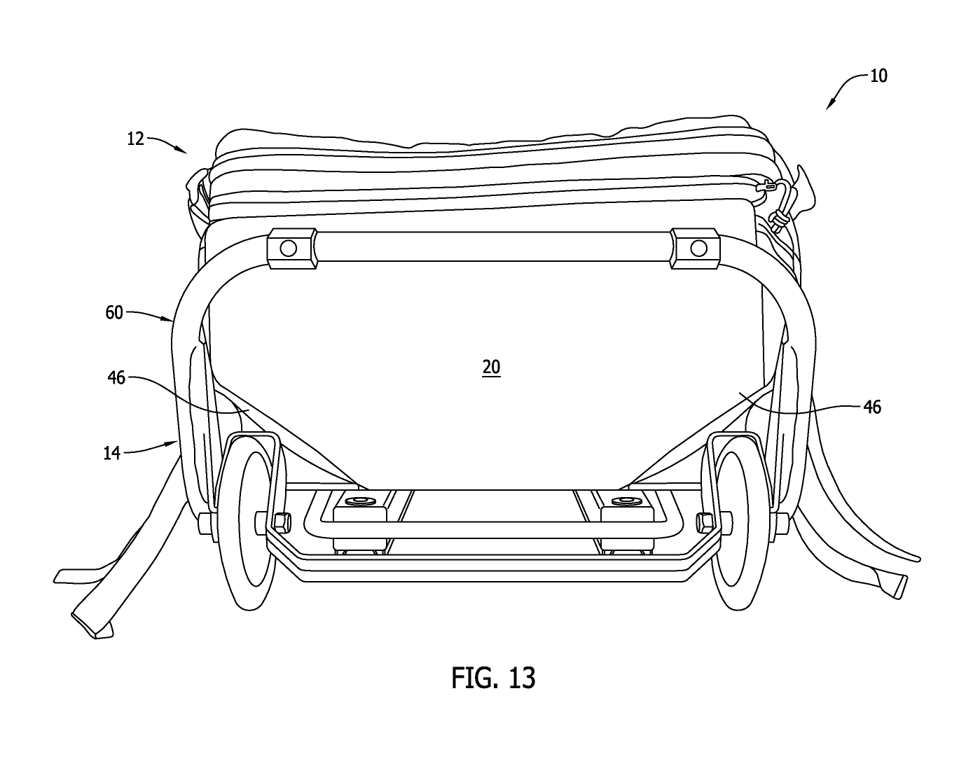

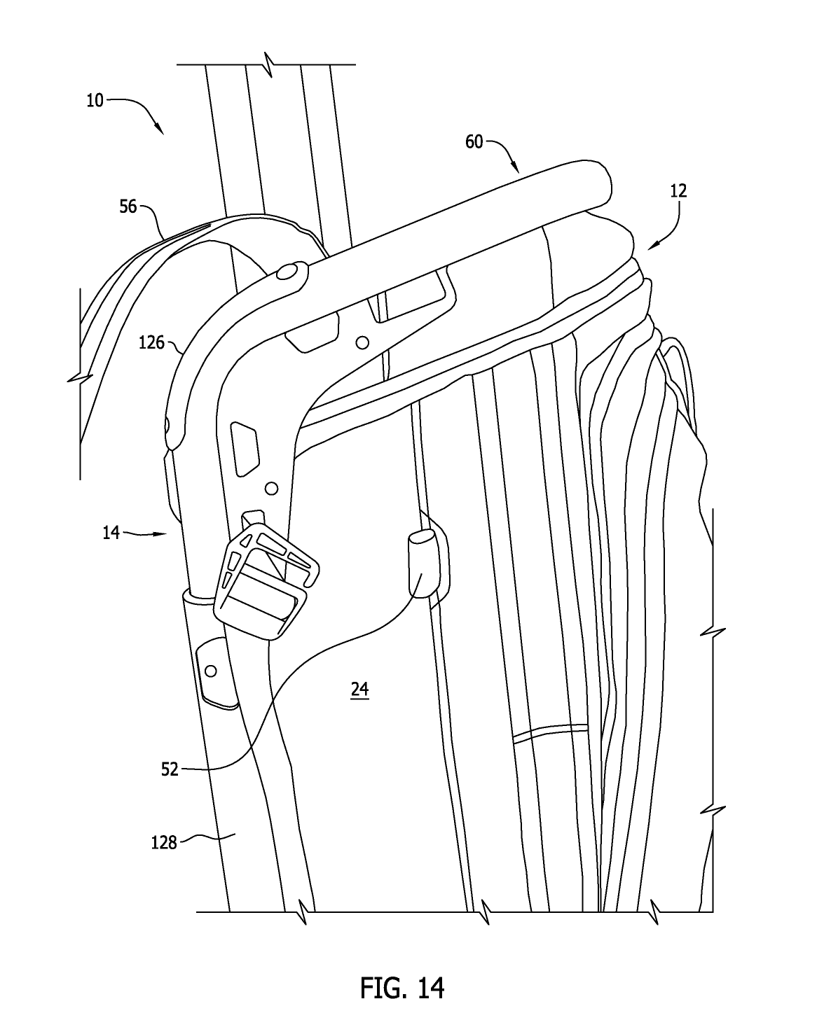

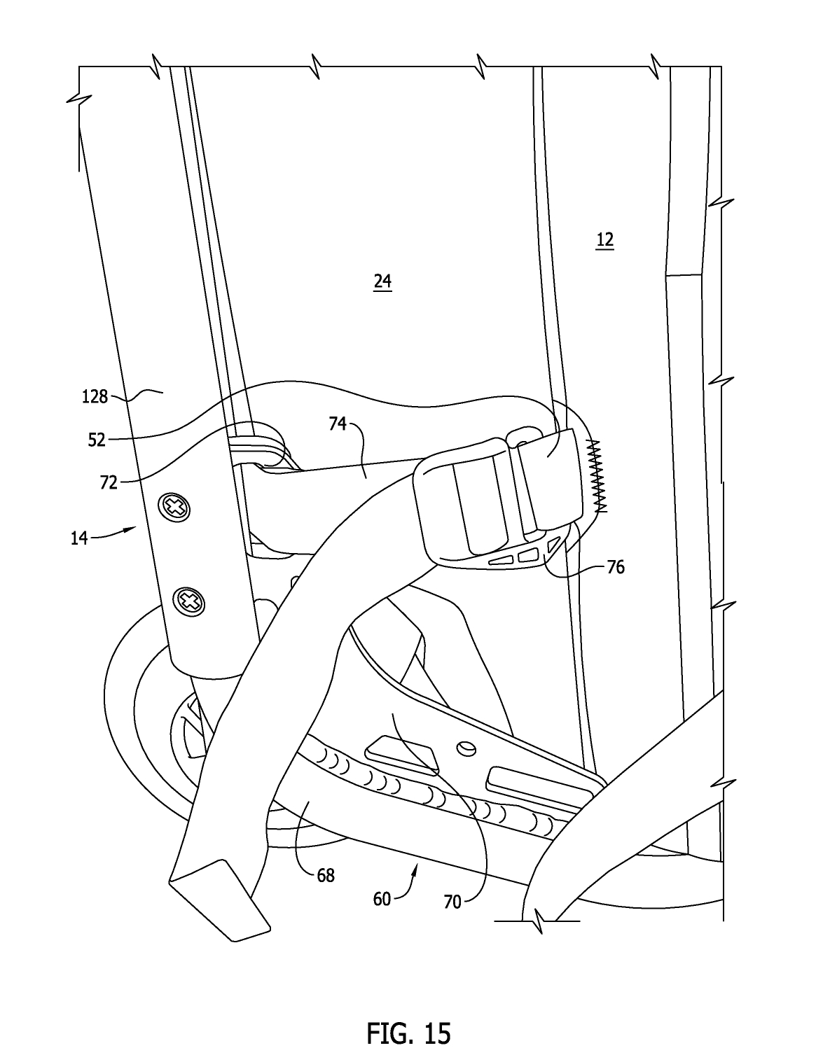

FIGS. 1-16 illustrate one suitable embodiment of a convertible luggage and luggage cart assembly, indicated generally at 10. As seen therein, the illustrated convertible luggage and luggage cart assembly 10 comprises a piece of luggage (e.g., a packbag, which is indicated generally at 12) and a cart, which is indicated generally at 14, adapted to support and transport the packbag thereon. In the illustrated embodiment, the packbag 12 is secured to the cart 14 so that the packbag can be carried or wheeled with the cart as an assembly and that the cart can be carried with the packbag as an assembly. The packbag 12 can selectively detached from the cart 14 such that the packbag can used independently of the cart 14 and the cart can be used independently of the packbag.

The packbag 12, which is expandable, includes a back panel 16, a top panel 18, a bottom panel 20, two side panels (i.e., a right side panel 22 and a left side panel 24 as viewed in FIG. 1), and a front panel 26. The panels 16, 18, 20, 22, 24, 26 cooperatively define at least one interior compartment (not shown) adapted to store objects for transportation in the packbag. The illustrated packbag 12, for example, includes two interior compartments. One of the interior compartments is accessible via a zipper 28 disposed on the front panel 26. The interior compartment accessible via zipper 28 can be selectively expanded outward (or compressed inward if expanded) using zipper 30. More specifically, the transverse extent (i.e., the depth or thickness) of the packbag 12 can be selectively increased or decreased by moving the packbag between an expanded configuration and a collapsed configuration by unfastening and fastening the zipper 30. It is contemplated that in some embodiments of the packbag 12 the expandable portion adapted to increase the transverse extent of the packbag can be omitted.

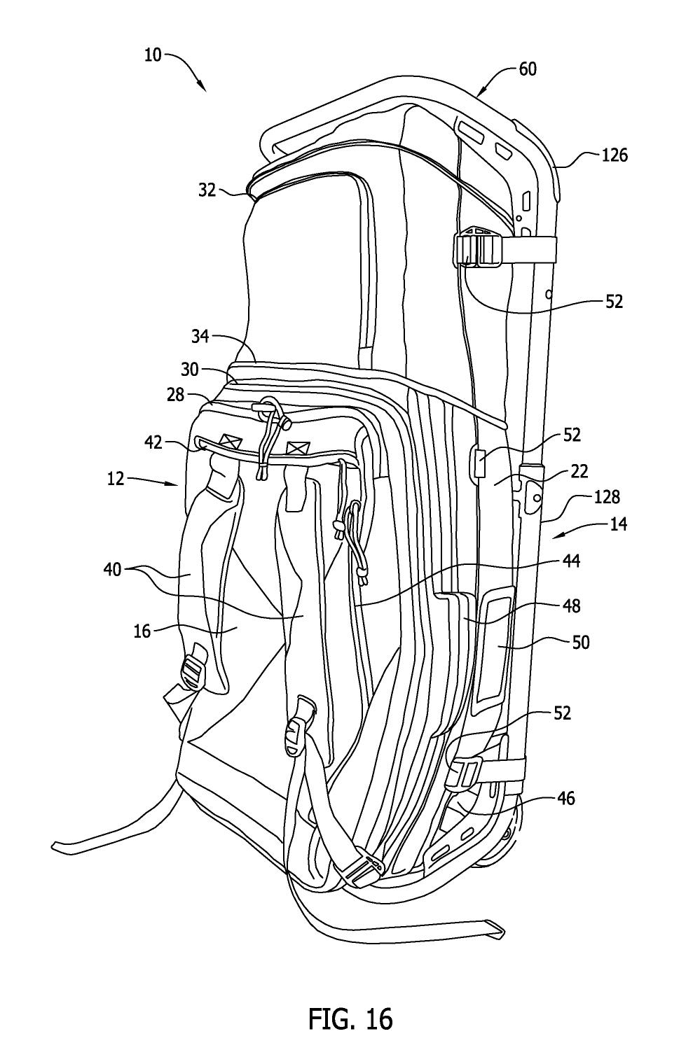

The second interior compartment is accessible via another zipper 32, which is seen in FIG. 16. The second interior compartment and the associated zipper 32 can be retained in a compressed configuration, which is seen in FIG. 1, by fastening a zipper 34, and be selectively moved to an expanded and usable configuration by unfastening the zipper, as seen in FIG. 16. Thus, the longitudinal extent (i.e., the length) of the packbag 12 can be selectively increased or decreased by moving the packbag between the expanded configuration and the collapsed configuration.

It is contemplated the packbag 12 can have more or fewer compartments than illustrated herein and that the compartments can have any suitable configuration. It is also contemplated that the packbag 12 can have more or fewer expandable portion and that the expandable portions can have any suitable configuration. It is further contemplated the compartments and/or the expandable portions of the packbag 12 can be secured or fastened using any suitable fastener, such as, straps, buckles, buttons, and snaps.

The illustrated packbag 12 also includes two pockets (not shown). One of the pockets is provided for storing straps 40 of the packbag 12 and is accessible via a zipper 42. The other pocket, which is accessible via a zipper 44, can be used to store objects (e.g., generally flat objects such as papers, magazines, electronic tablets). It is contemplated the packbag 12 can have more or fewer pockets than illustrated herein. It is also contemplated the pockets of the packbag 12 can be secured or fastened using any suitable fastener, such as, straps, buckles, buttons, and snaps.

In one suitable embodiment, the panels 16, 18, 20, 22, 24, 26 are connected to each other by stitching and are formed from a sufficiently soft and compliant material. One or more of the panels 16, 18, 20, 22, 24, 26 can be padded using foam, batting or any other suitable padding material or can be reinforced using any suitable rigid material such as a rigid plastic or cardboard. The outer material of the panels 16, 18, 20, 22, 24, 26 can be any suitable material, including but not limited to, nylon and polyester. Suitably, the outer material of the panels 16, 18, 20, 22, 24, 26 is durable and stain resistant.

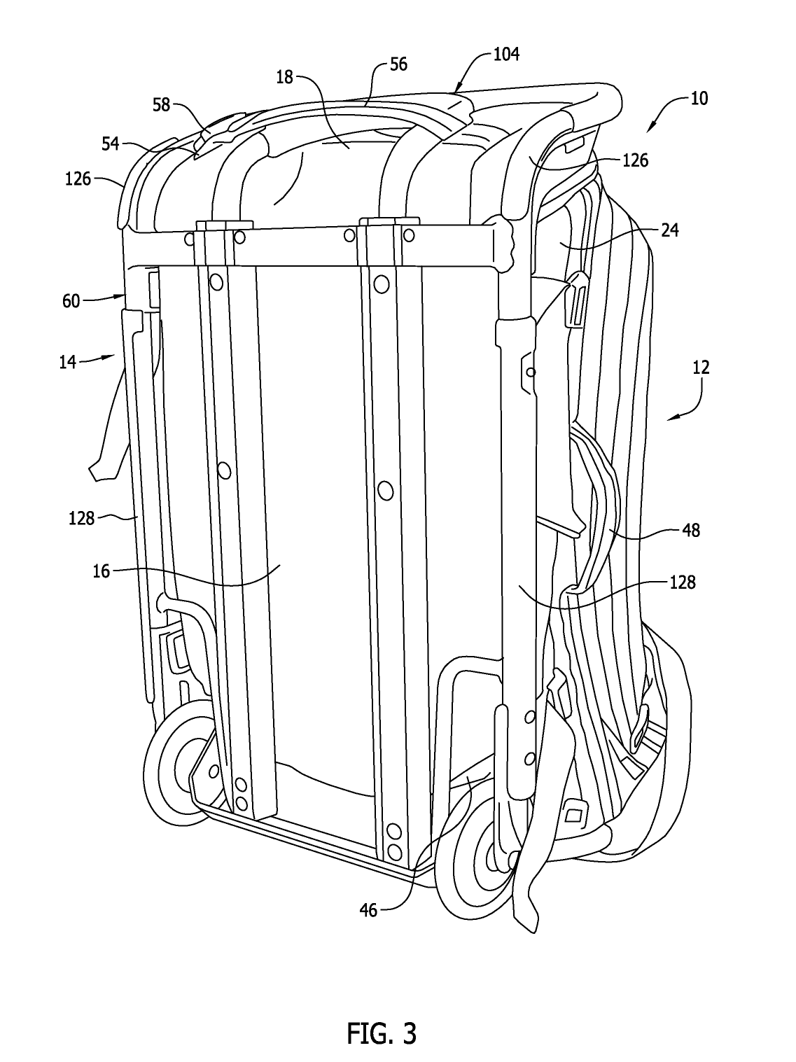

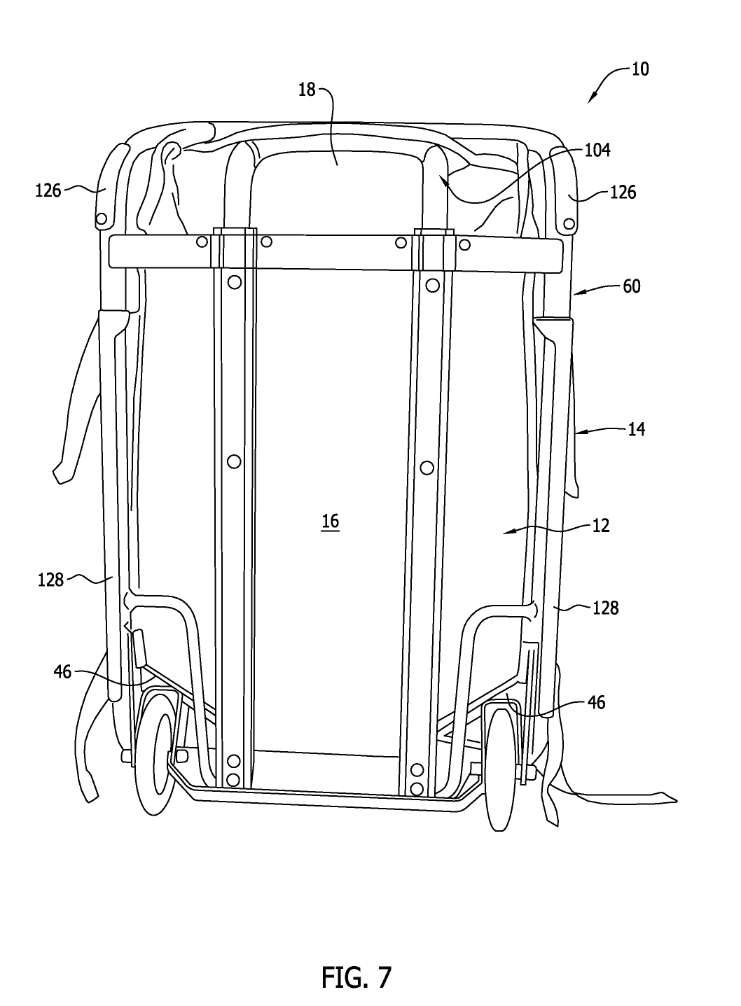

With reference to FIG. 7, the packbag 12 further includes a pair of wheel wells 46. One of the wheel wells 46 is disposed near or at the intersection of the back panel 16, the bottom panel 20 and the right side panel 22 and the other wheel well is disposed near or at the intersection of the back panel, the bottom panel and the left side panel 24. Each of the right and left side panels 22, 24 include handles 48 for carrying the packbag 12 and/or the convertible luggage and luggage cart assembly 10 in a generally horizontal orientation. The handle 48 on the right side panel 22 of the packbag 12 can be seen in FIG. 1 and the handle 48 on the left side panel can be seen in FIG. 3. Thus, the packbag 12 (if used without the luggage cart 14) or the assembly 10 (if the packbag is attached to the cart) can be manually carried sideways via either the handle 48 on the right side panel 22 or the handle on the left side panel 24. It is contemplated that the packbag 12 can have more or fewer handles 48 than illustrated herein and/or that the handles can be located on other panels of the packbag in addition to or instead of the right and left side panels.

The right side panel 22 of the illustrated embodiment of the packbag 12 includes a pocket 50 having a transparent face and adapted to receive an owner identification/contact card (i.e., a luggage tag). It is understood that the pocket 50 can be omitted or placed on a different panel of the packbag 12.

Each of the right and left side panels 22, 24 of the packbag 12 include a plurality of loops 52 (generally, “a first fastening member”). In the illustrated embodiment, each of the right and left side panels 22, 24 have three loops 52 but it is understood that more or fewer loops can be provided. The loops 52 located on the right side panel 22 of the packbag 12 are illustrated in FIG. 16. The upper most loop 52 seen in FIG. 16 is only accessible when the packbag is expanded longitudinally. Thus, the upper most loops 52 on the right and left side panels 22, 24 are inaccessible when the packbag 12 is in the longitudinally compressed configuration, which is seen in FIG. 1, and accessible when the packbag is in the longitudinally expanded configuration of FIG. 16. As described in more detail below, it is contemplated that other types of suitable fastening members besides the illustrated loops 52 can be used.

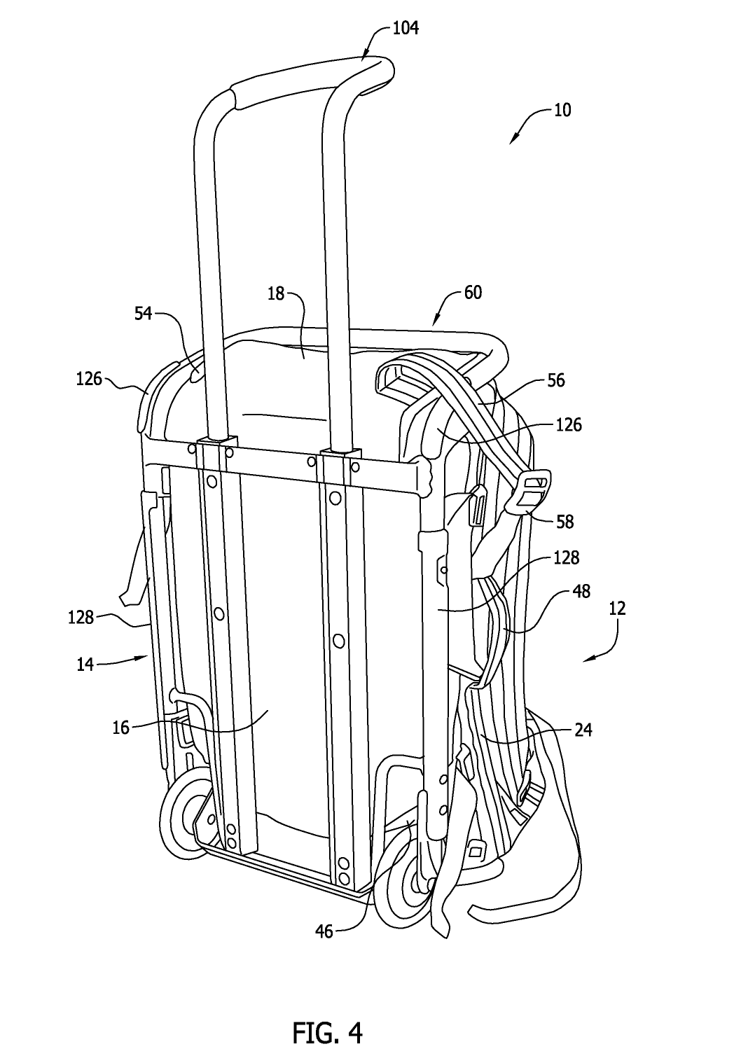

With reference now to FIGS. 3 and 4, the top panel 18 of the illustrated packbag 12 includes a loop 54 (broadly, “a first fastening component”) and a strap 56 having a buckle 58 (broadly, “a second fastening component”) that is selectively attachable and detachable from the loop. The buckle 58 is seen attached to the loop 54 in FIG. 3 and detached from the loop in FIG. 4. It is understood that the loop 54 and buckle 58 can be any suitable fastening components. For example, in one suitable embodiment, the fastening components can include a female buckle and male buckle configured to selectively attach and detach from the female buckle via a snap fit. It is also understood that the strap and loop can be omitted in some embodiments of the packbag 12.

With reference again to FIG. 1, the front panel 26 of the packbag 12 includes a pair of shoulder straps 40 for carrying the packbag alone (when the packbag is detached from the cart 14) or the assembly 10 (when the packbag is attached to the cart) in a generally vertical orientation. That is, the packbag 12 (if used without the luggage cart 14) or the assembly (if the packbag is attached to the luggage cart) can be carried generally upright on the user's back. It is contemplated that the packbag 12 can be provided with a single strap 40 (i.e., a sling bag).

In the illustrated embodiment, one end of each of the straps 40 can be selectively attached and detached from the front panel 26. When the ends of the straps 40 are detached, the straps can be stored and enclosed in the pocket accessible via zipper 42. Storage of the straps 40 facilitates checking the bag with an airline since checked luggage is often moved by the airline using a mechanical conveyor system and/or is directed through an inspection system. Enclosing the straps 40 in the pocket prevents the straps from being snagged or otherwise caught on the mechanical conveyor system and/or the inspection system.

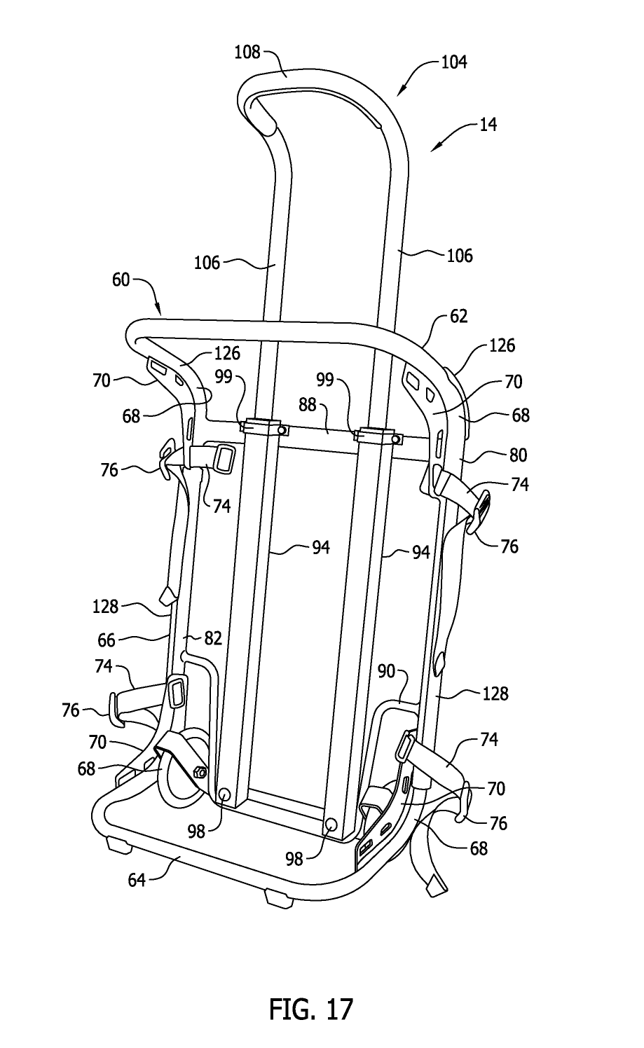

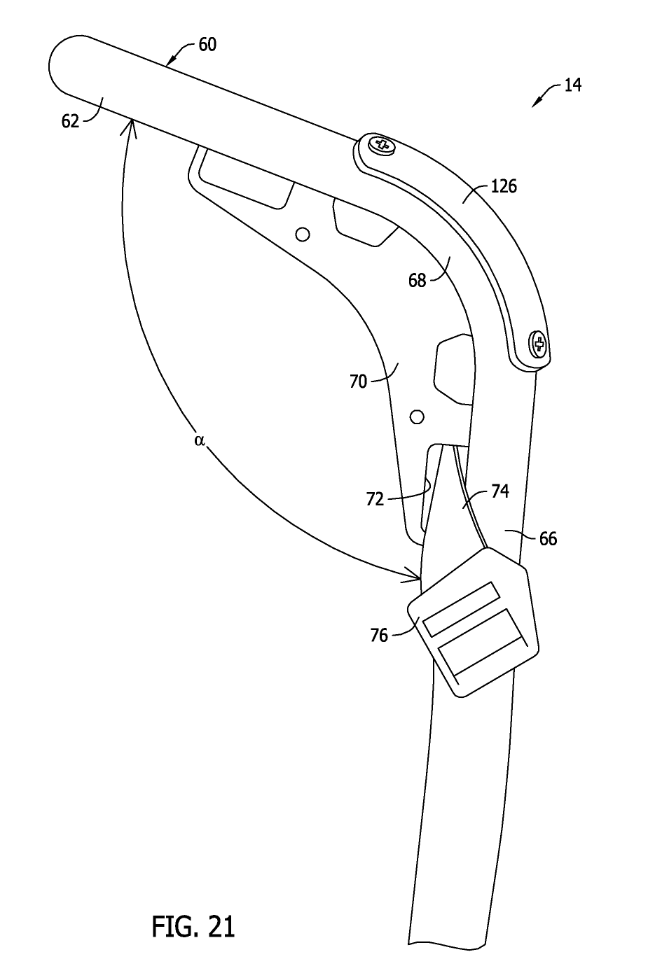

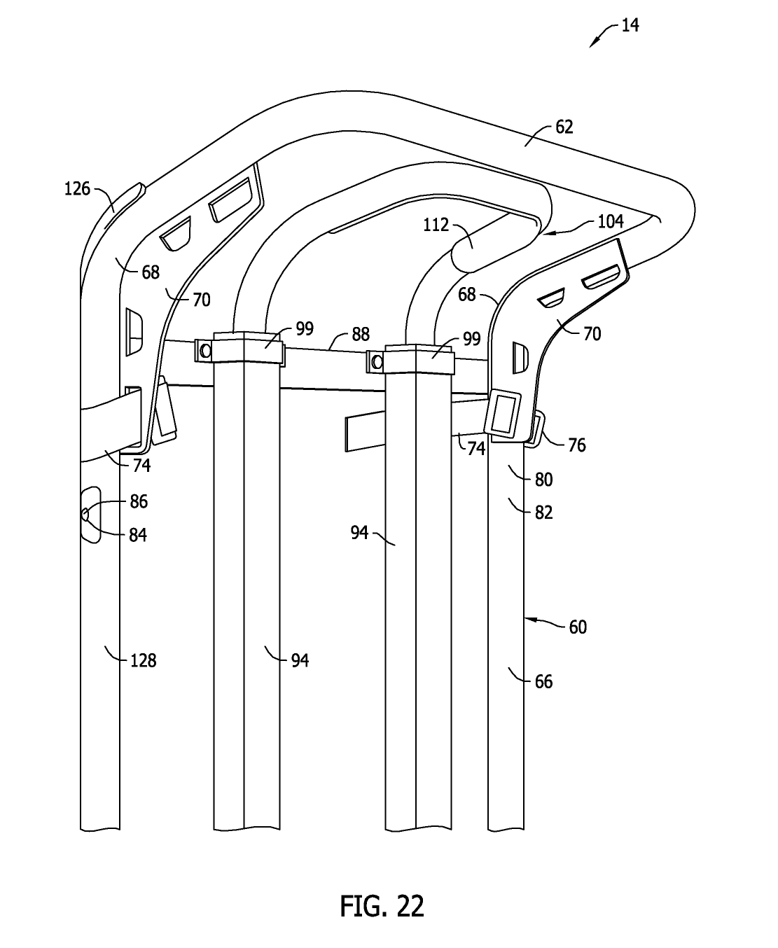

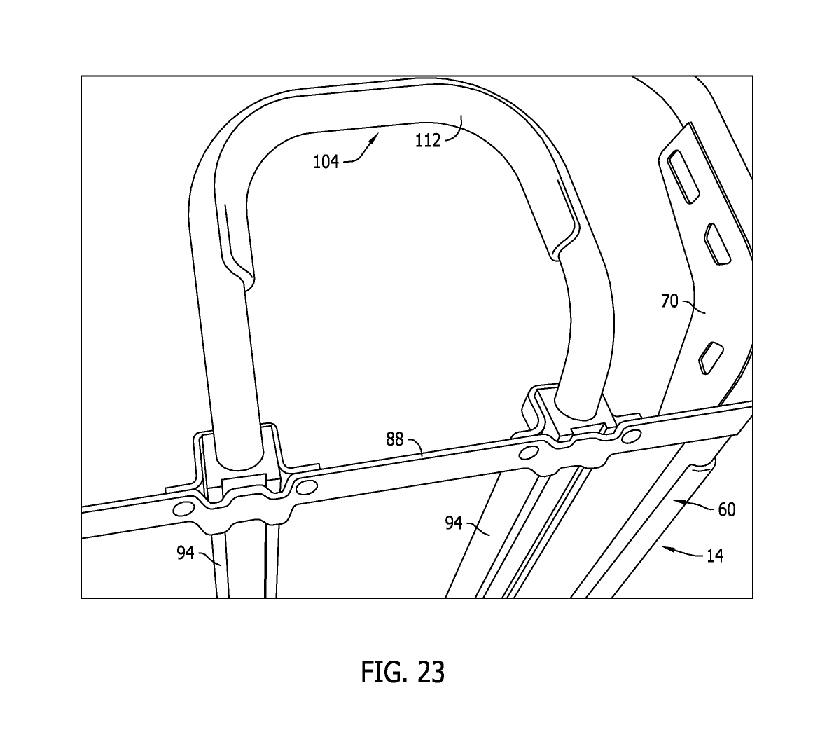

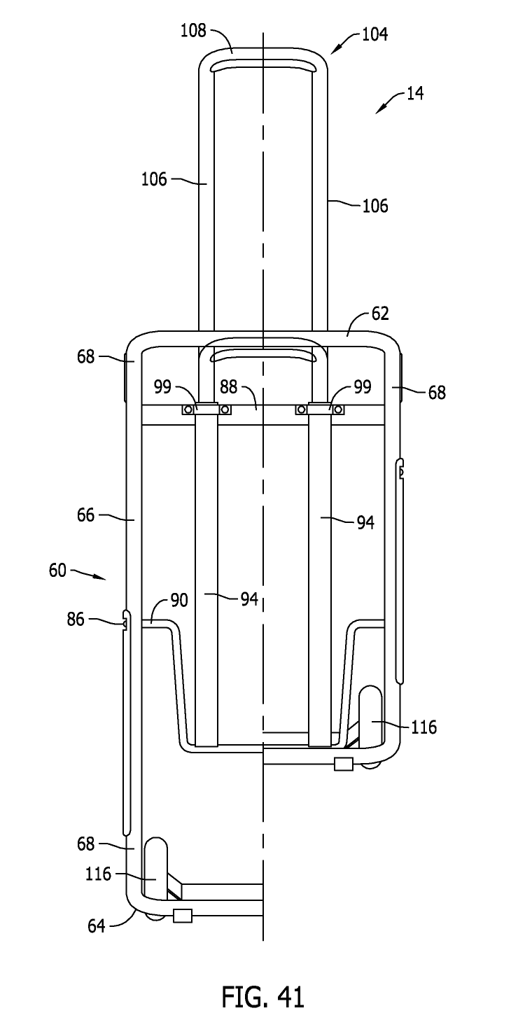

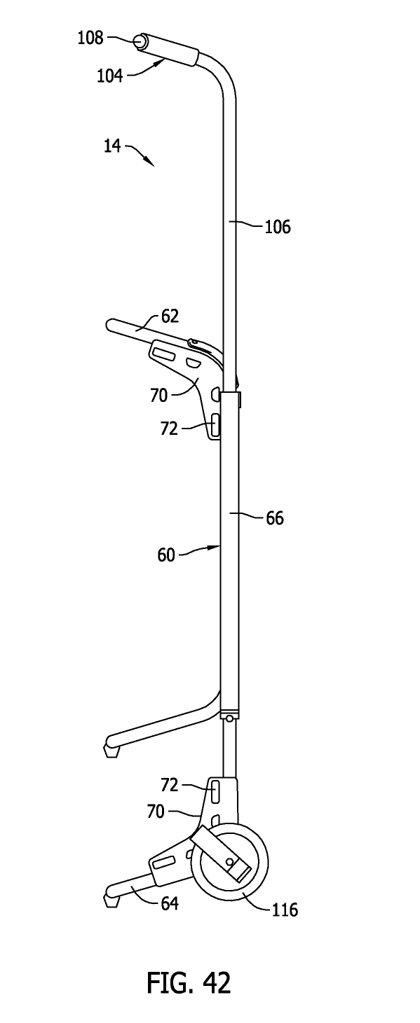

As seen in FIGS. 17-23 and 40-46, the luggage cart 14 includes a tubular frame, indicated generally at 60, having an upper portion 62, a lower portion 64, and a middle portion 66 extending between and connecting the upper and lower portions. The upper and lower portions 62, 64 are angled relative to the middle portion 66 to define four rounded corners 68. In one suitable embodiment, the upper and lower portions 62, 64 are angled relative to the middle portion 66 at an angle a greater than 90 degrees and less than 135 degrees (FIG. 21). In the illustrated embodiment, the upper and lower portions 62, 64 are angled the same relative to the middle portion 66. More specifically, the upper portion 62 of the illustrated embodiment has an angle of approximately 106 degrees with the middle portion 66 and the lower portion 64 has an angle of approximately 106 degrees with the middle portion (FIG. 42). It is contemplated, however, the upper portion 62 can be angled relative to the middle portion 66 differently than the lower portion 64.

As seen in FIG. 17, each of the rounded corners 68 is reinforced by a support bracket 70. The support brackets 70, which in the illustrated embodiment are welded to the respective corner 68, rigidify the frame 60. More specifically, the support brackets 70 inhibit the upper and lower portions 62, 64 from bending or otherwise moving relative to the middle portion 66 during use. It is contemplated that the support brackets 70 can be attached to the frame 60 in other suitable manners besides welding. It is also contemplated that the support brackets 70 can have different shapes and configurations than those illustrated herein.

With reference now to FIG. 21, each of the support brackets 70 includes at least one cutout 72 having a strap 74 securely looped around the middle portion 66 of the frame 60 and through the cutout. Each of the straps 74 includes a buckle 76 (broadly, a “second fastening member”) for selectively attaching to a respective one of the loops 52 on the right and left side panels 22, 24 of the packbag 12. More specifically, the buckles 76 disposed on the support brackets 70 mounted to the upper portion 62 of the frame 60 are adapted to selectively attach to the upper loops 52 or the middle loops on the right and left side panels 22, 24 of the packbag 12 (as seen in FIG. 16). The buckles 76 disposed on the support brackets 70 mounted to the lower portion 64 of the frame 60 are adapted to selectively attach to the lower loops 52 (as seen in FIG. 16) on the right and left side panels 22, 24 of the packbag 12. It is understood that the loops 52 and the buckles 76 can be any suitable fastening components. For example, in one suitable embodiment, the fastening components can include a female buckle and male buckle configured to selectively attach and detach from the female buckle via a snap fit.

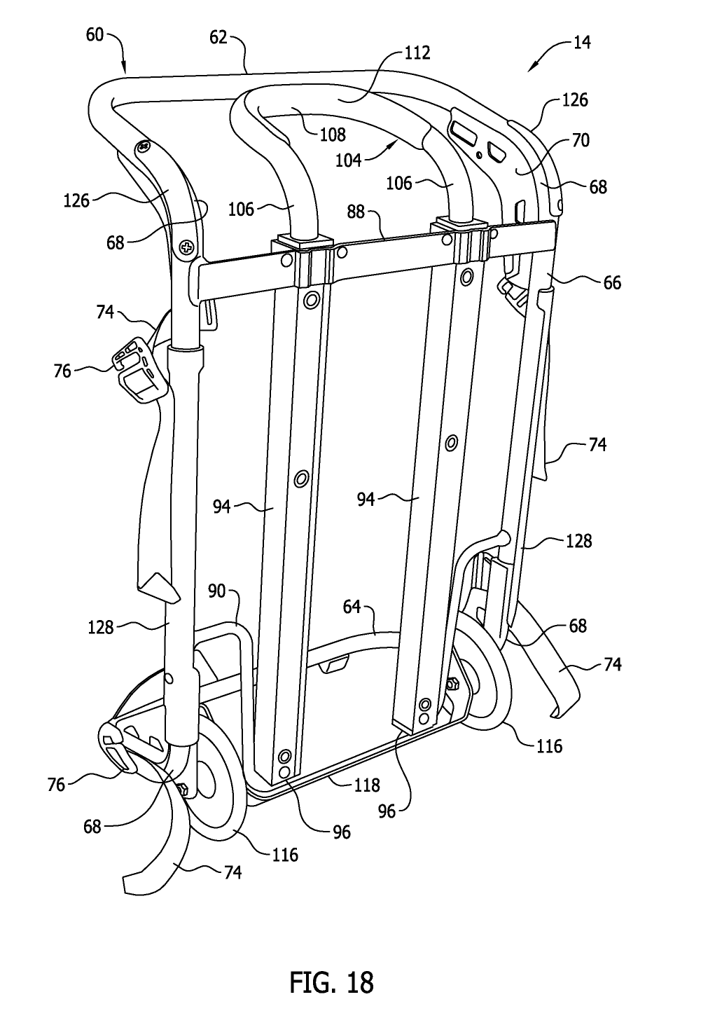

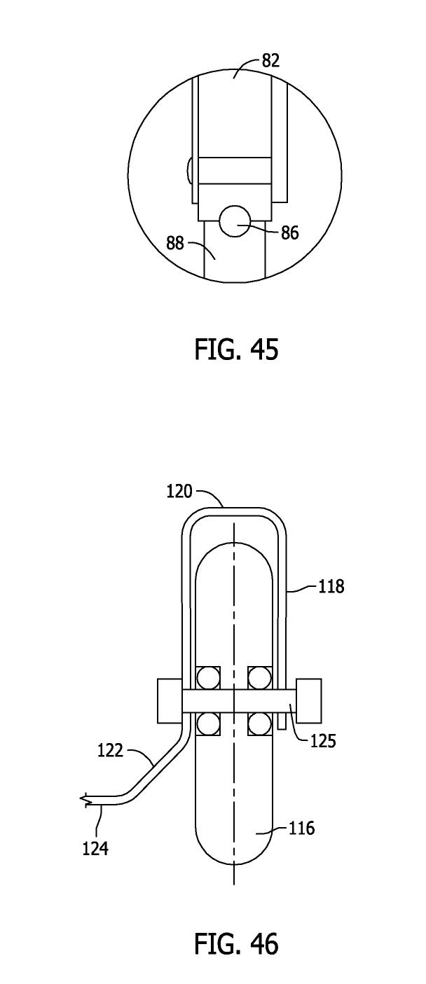

The middle portion 66 of the frame 60 is telescopic so that the luggage cart 14 can be moved between a retracted position and an extended position. More specifically, the middle portion 66 of the frame 60 includes a pair of spaced apart inner tubes 80 slidingly received within a pair of spaced apart outer tubes 82. Each of the outer tubes 82 has two apertures 84 for allowing a spring loaded stop 86 to extend through the aperture and thereby lock the luggage cart 14 in either the retracted position or the extended position (FIG. 45). The luggage cart 14 can be moved from the retracted position seen in FIGS. 17 and 18 to the extended position seen in FIG. 16 by manually pushing inward both of the stops 86 such that the stops are spaced inward of the respective apertures 84 and pulling the outer tubes 82 upward and/or pulling the inner tubes downward until the stops, which are spring loaded, extend through the other set of apertures (i.e., the upper set of apertures) to thereby lock the luggage cart in the extended position. Conversely, the luggage cart 14 can be moved from the extended position to the retract position by manually pushing inward both of the stops 86 such that the stops are spaced inward of the respective apertures 84 and pushing the outer tubes 82 downward and/or push the inner tubes 80 upward until the stops, which are spring loaded, extend through the other set of apertures (i.e., the lower set of apertures) to thereby lock the luggage cart in the refracted position. It is understood that the luggage cart can be extendable and retractable using other suitable techniques and between more than the two positions illustrated herein. For example, the luggage cart can be locked in the retracted and extended positions using known locking pins (e.g., detent pins).

In one suitable embodiment, the frame 60 is made from a relatively light weight tubular metal, such as, aluminum tubing. It is understood, however, that the frame 60 can be made from any suitable material including other types of metal and plastic. In the illustrated embodiment, half (e.g., the upper half of the illustrated frame) of the frame is made from a piece of metal tubing having a first diameter, and the other half (e.g., the lower half of the illustrated frame) is made from another piece of metal tubing having a second diameter. The second diameter is sufficiently larger than the first diameter so that the tubing forming the upper half of the frame 60 can be slideably inserted into the tubing forming the lower half The metal tubing forming the frame 60 can bent into the desired shape using conventional techniques. In one suitable embodiment, the frame 60 generally aligns with the perimeter (i.e., outer edges) of the top panel 18, back panel 16 and bottom panel 20 of the packbag 12 when the packbag is secured to the frame (see, e.g., FIGS. 1 and 16). As a result, the frame 60 protects the packbag and its contents from damage.

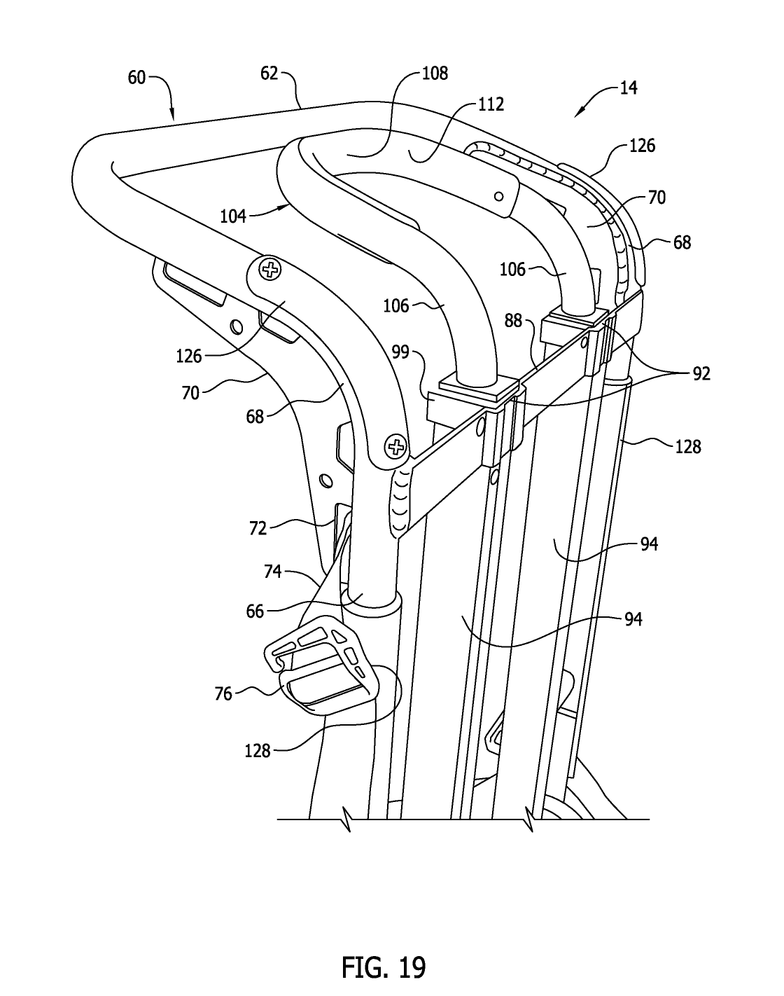

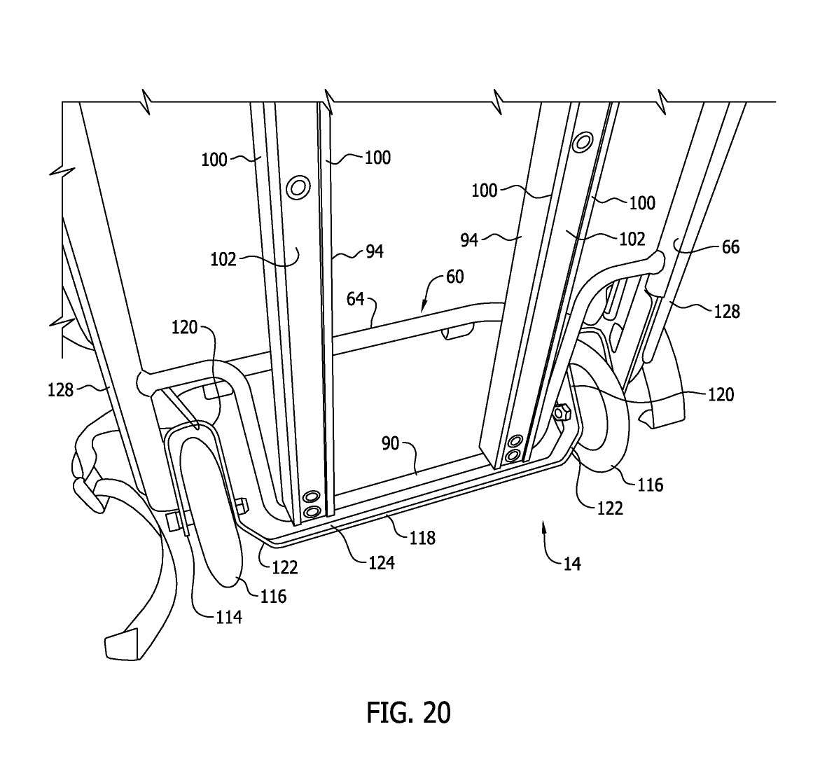

With reference now to FIG. 18, the luggage cart 14 includes a support bar 88 extending between the middle portion 66 of the frame 60 adjacent the upper portion 62, and a support rod 90 extending between the middle portion of the frame adjacent the lower portion 64. In the illustrated embodiment, the support bar 88 is a generally rectangular flat bar that is welded (or otherwise attached) to the middle portion of the frame at or near the respective corners 68. As seen in FIGS. 19 and 43, the support bar 88 is bent to form two, spaced apart recesses 92. The support rod 90 of the illustrated embodiment is formed using a metal rod that is welded (or otherwise attached) to the middle portion 66 of the frame 60 generally adjacent the lower portion 64 of the frame (FIGS. 18 and 20). More specifically, the support rod 90 is welded to the middle portion 66 at a location spaced from the respective corners 68 and above each of the support brackets 70. The support rod 90 is bent so that the middle part of the rod lies generally in the same plane as the lower portion 64 of the frame 60.

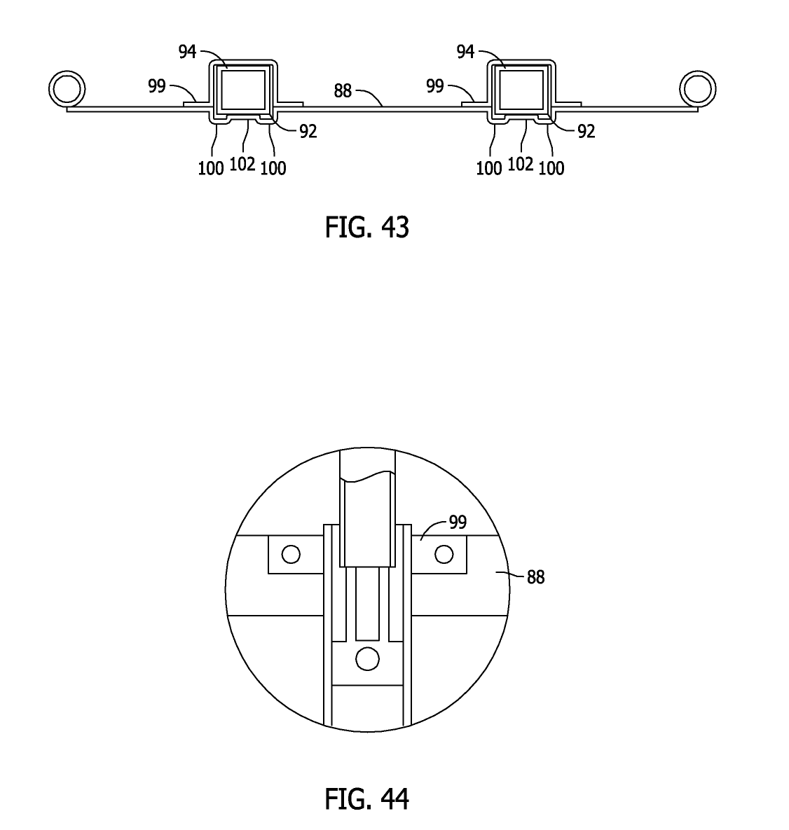

With references to FIGS. 18-20 and 41, two spaced apart tubular sleeves 94 are mounted on the support bar 88 and the support rod 90. More specifically, a pair of mounts 96 is welded to the support rod 90 and the sleeves are bolted (or otherwise secured) to the mounts using suitable fasteners 98. As seen in FIGS. 19 and 43, the sleeves 94 are received in the recesses 92 formed in the support bar 88. A bracket 99 is bolted to the support bar 88 adjacent each of the recesses 92 to capture the respective sleeve 94 and thereby secure each of the sleeves to the support bar (FIG. 44). Each of the sleeves 94 of the illustrated embodiment of the cart 14 has a generally square cross-section but it is understood that the sleeves can have other suitable cross-section without departing from the scope of this invention. As seen in FIG. 20, each of the sleeves 94 include a pair of longitudinally extending ridges 100 and channel 102 extending between the ridges 100 on the backside of sleeve. The ridges 100 and channel 102 provided strength and rigidity to the each of the sleeves.

With reference now to FIGS. 17 and 18, a retractable handle, indicated generally at 104, includes a pair of downwardly extending cylindrical tube members 106 that are received within the sleeves 94 and a gripping portion 108 disposed between and interconnecting the two tube members. In the illustrated embodiment, the gripping portion 108 includes a grip 112 covering a portion thereof. The grip 112 can be formed from any suitable material and can cover more or lesser amounts of the handle 104. It is contemplated that the grip 112 can be omitted. The handle 104 can be manually moved between a stowed position (FIG. 18) and a use position (FIG. 17). In the use position, the handle 104 can be used to wheel convertible luggage and luggage cart assembly 10.

With reference now to FIGS. 3 and 4, the loop 54 and buckle 58 disposed on the top panel 18 of the packbag 12 can be used to secure the handle 104 in the stowed position. The buckle 58 is seen attached to the loop 54 and securing the handle 104 in the stowed position in FIG. 3. FIG. 4, on the other hand, shows the buckle 58 detached from the loop 54, which allows the handle 104 to be selectively moved between the stowed position and the use position. The handle 104 is in the use position in FIG. 4.

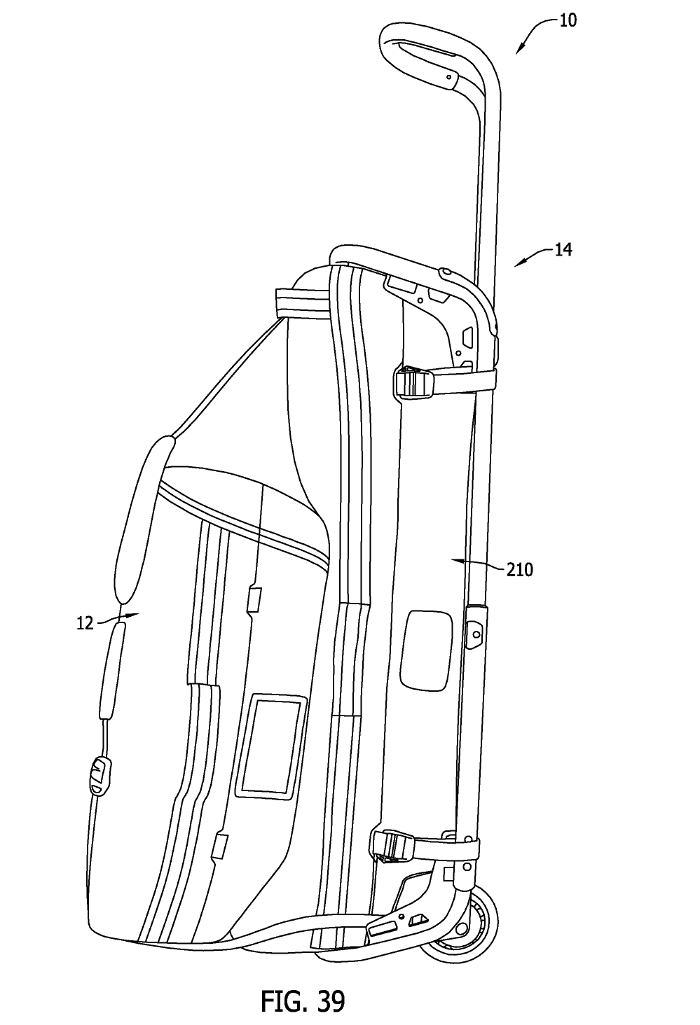

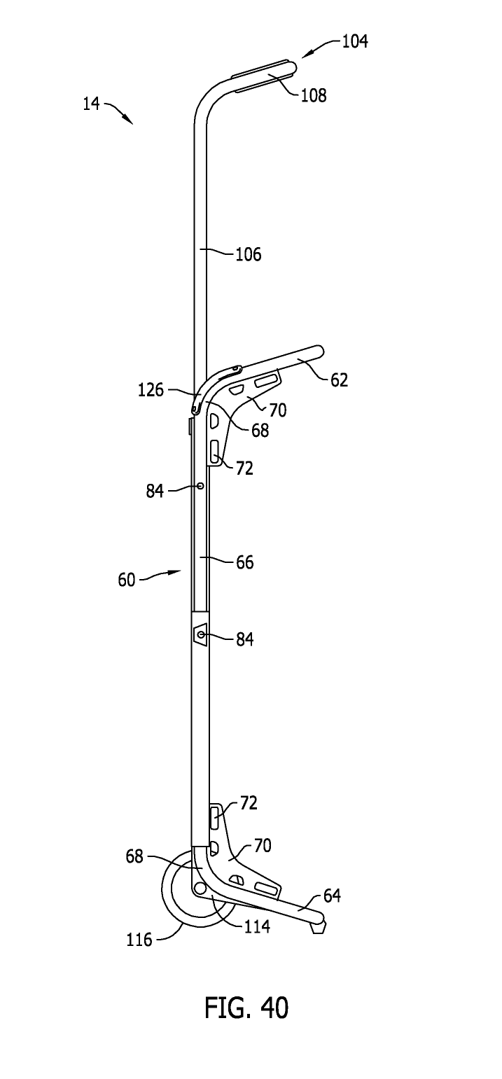

With reference now to FIGS. 20 and 40, the lower portion 64 of the frame 60 includes a pair of wheel mounting brackets 114 for mounting a pair of wheels 116 to the frame. In the illustrated embodiment, a wheel mounting bar 118 extends between each of the mounting brackets 114 and is used to mount the wheels 116 to the frame 60. It is contemplated, that in some suitable embodiments, the wheel mounting bar 118 can be omitted and a single axle can extend between wheel mounting brackets 114 of the frame 60 for mounting the wheels 116. In the illustrated embodiment, however, the wheel mounting bar 118 includes a pair of generally U- shaped portions 120, two angled portions 122, and a generally straight portion 124 extending between and connecting the angled portions 122. Each of the U-shaped portions 120 are sized and shaped to receive one of the wheels 116 therein and to fix the wheel to the frame 60. More specifically, each of the U-shaped portions 120 includes a pair of openings (not shown) for receiving an axle 125 to which a respective one of the wheels 116 is rotatably mounted (FIG. 46).

In the illustrated embodiment, the middle part of the support rod 90 lies below the axles mounting the wheels 116 when the cart 14 is in the retracted position. This configuration allows the length of the handle 104 to be longer and/or more of the tube members 106 to be received with in the respective sleeve 94. The sleeves 94 inhibit damage to the handle 104 and, more specifically, to the tube members 106 of the handle 104. Damage to the tuber members 106 of the handle 104 can inhibit movement of the handle 104 between its stowed and use positions.

The illustrated cart 14 includes a plurality of guards attached to the frame 60. More specifically and with reference to FIGS. 19 and 20, the frame 60 includes a pair of plastic corner guards 126 attached to frame at the corners 68 extending between the upper portion 62 and middle portion 66 of the frame 60. As seen in FIGS. 18 and 20, the frame 60 also includes a pair of plastic guards 128 extending longitudinally along the lower part of the middle portion 66 of the frame 60. It is contemplated more or less of the frame 60 can be provided with guards. It is also contemplated that the guards can be omitted.

With reference again to FIGS. 1-17, the convertible luggage and luggage cart assembly 10 is sized and configured to be carried onto an aircraft in the collapsed configuration of the packbag 12 and the retracted position of the cart 14. That is, the convertible luggage and luggage cart assembly 10 is in compliance with most airline regulations for carry-on luggage. More specifically, the maximum size of the luggage and luggage cart assembly 10 is less than or equal to 45 linear inches (the total of the height, width, and depth of the assembly) when the packbag 12 is longitudinally and transversely collapsed and the cart 14 is retracted. Accordingly, an airline traveler using the convertible luggage and luggage cart assembly 10 illustrated in FIGS. 1-17 can carry the assembly onto the aircraft and store it in an overhead compartment. Alternatively, the airline traveler can check the illustrated luggage and luggage cart assembly 10 such as when the assembly is used in the expanded configuration of the packbag 12 and the extended position of the cart 14. As mentioned above, the frame 60 of the cart 14 protects the packbag 12 from damage.

With reference again to FIG. 1, the front panel 26 of the packbag 12 is free of the luggage cart 14. As a result, the user can freely use shoulder straps 40 to carry the convertible luggage and luggage cart assembly 10 without interference from the luggage cart 14. Moreover, the user can freely access any of the interior compartment or pockets of the illustrated packbag 12 while the packbag is attached to the luggage cart 14 and without interference from the luggage cart.

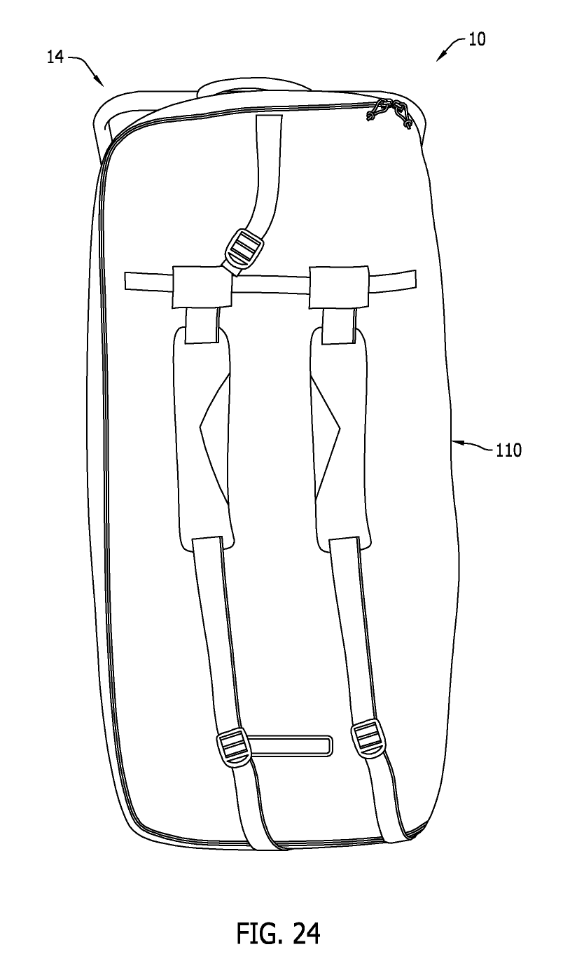

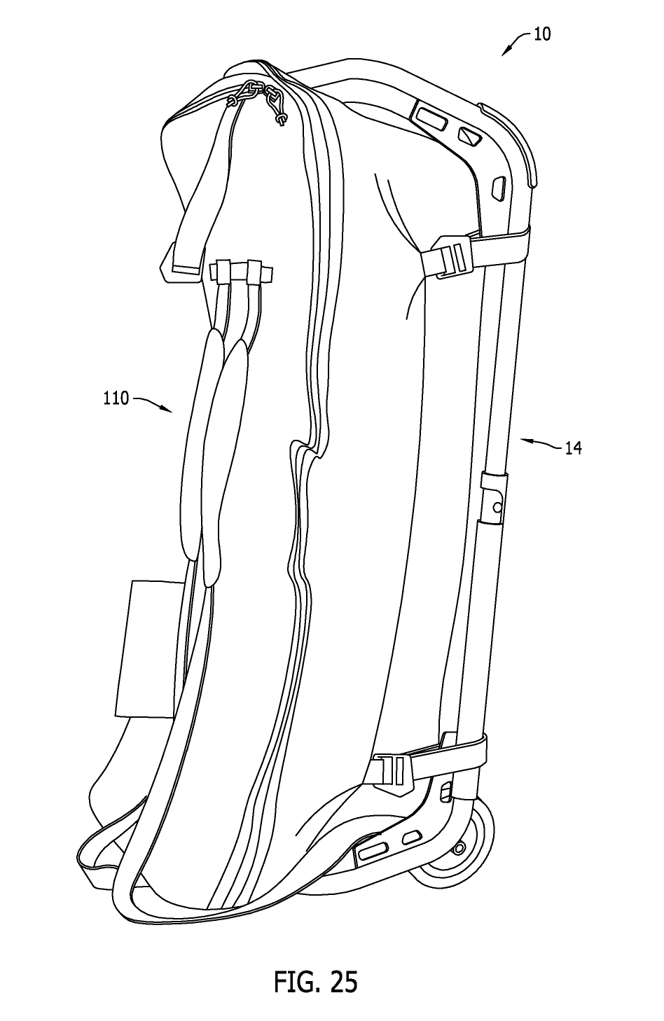

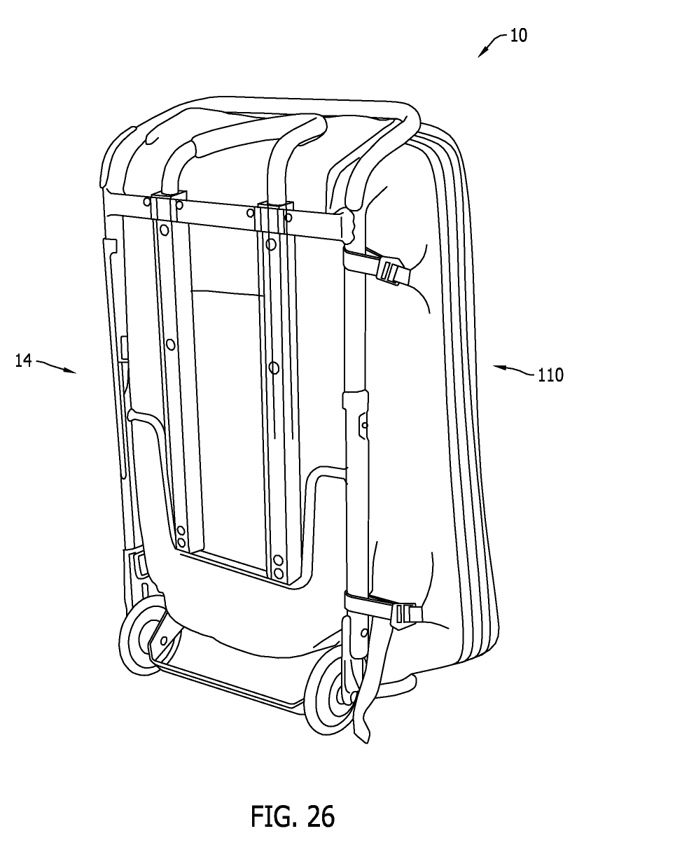

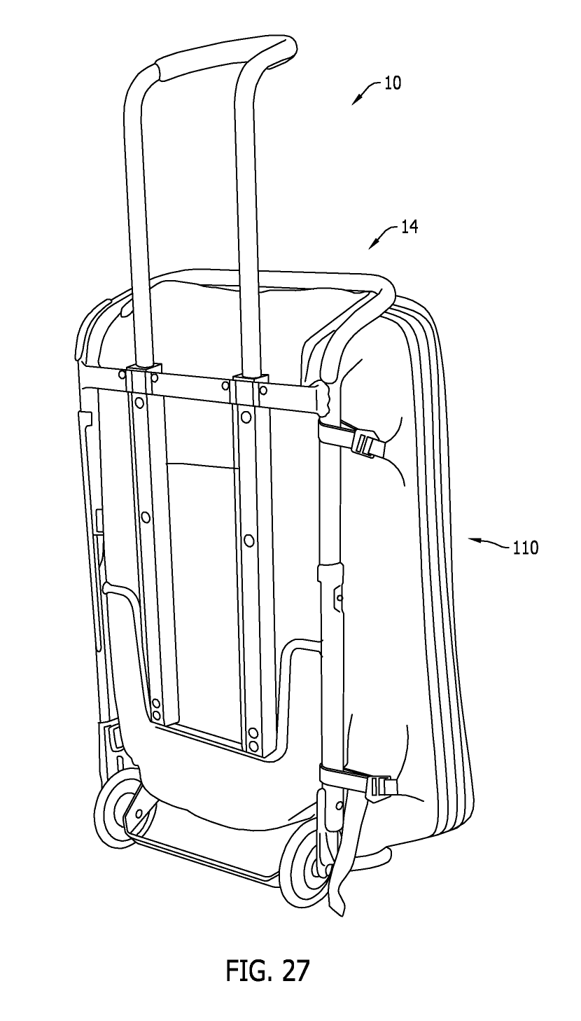

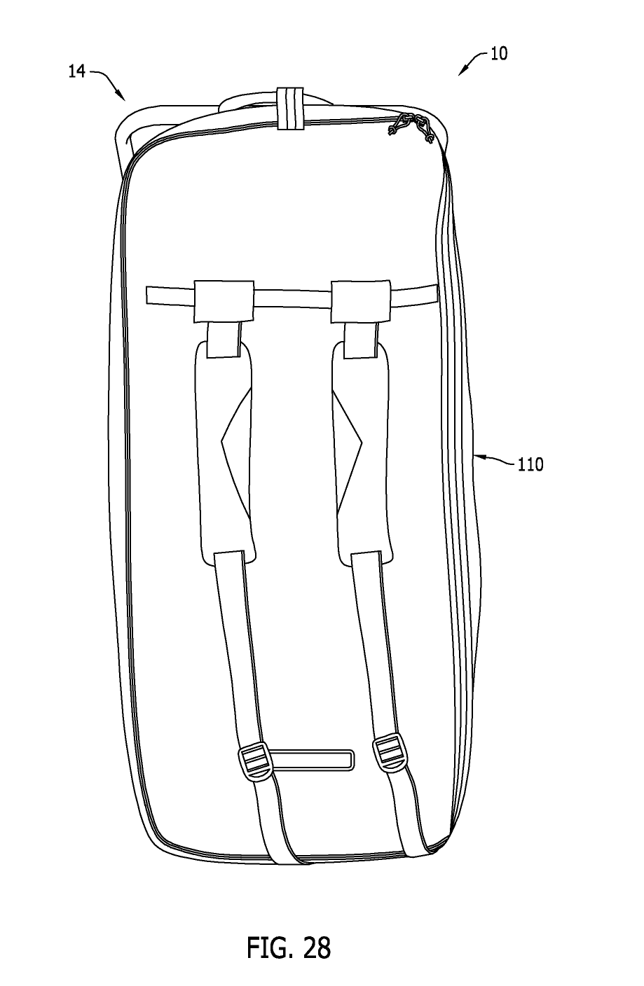

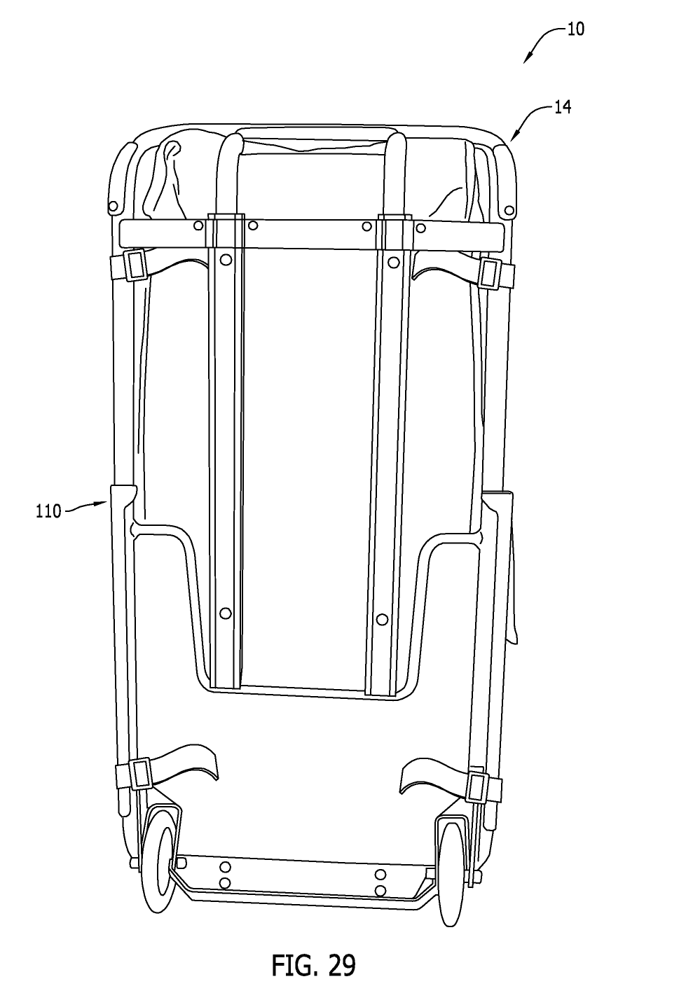

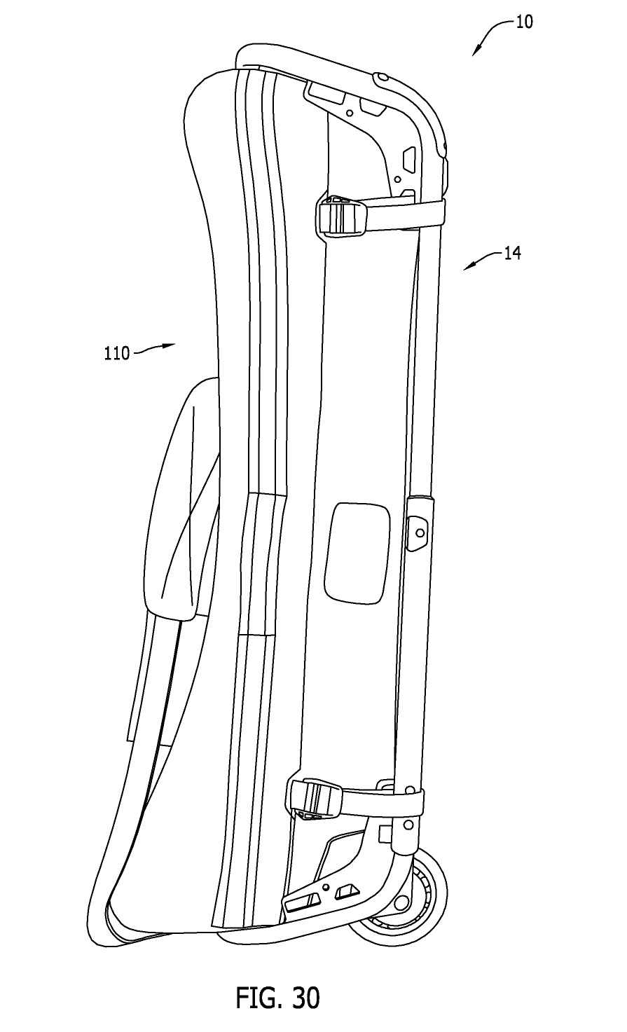

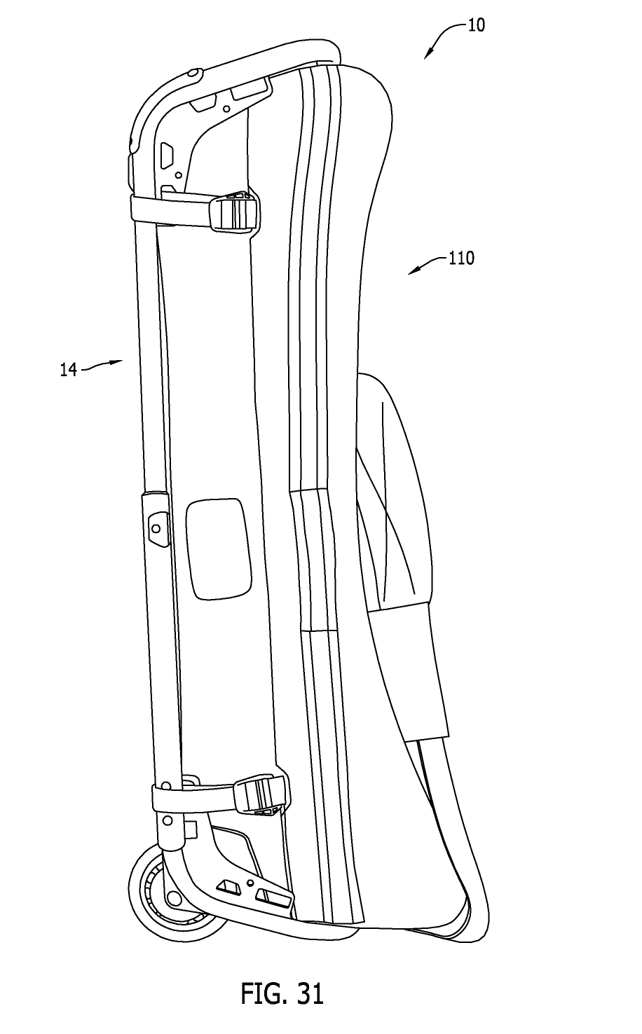

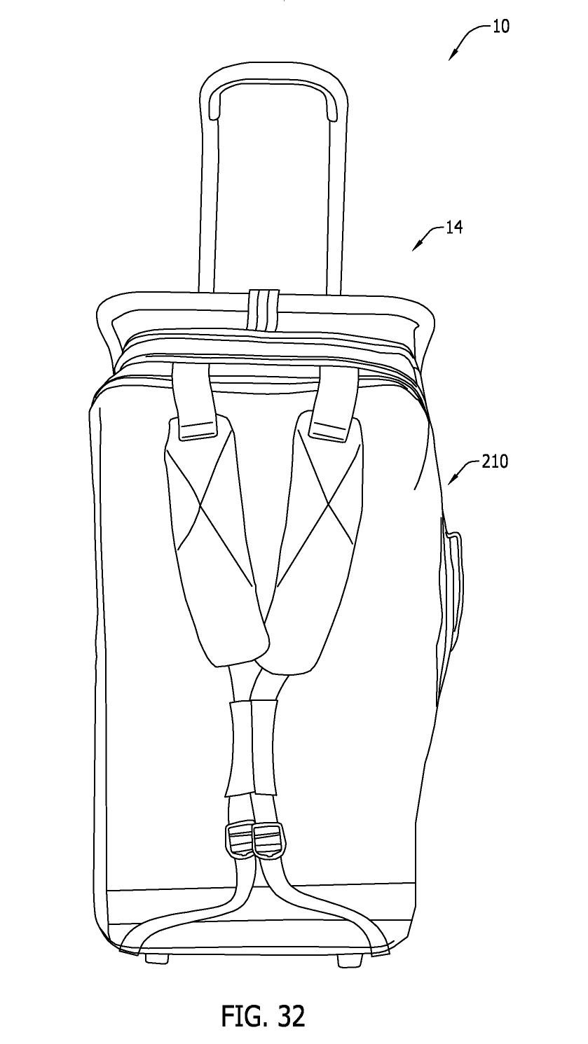

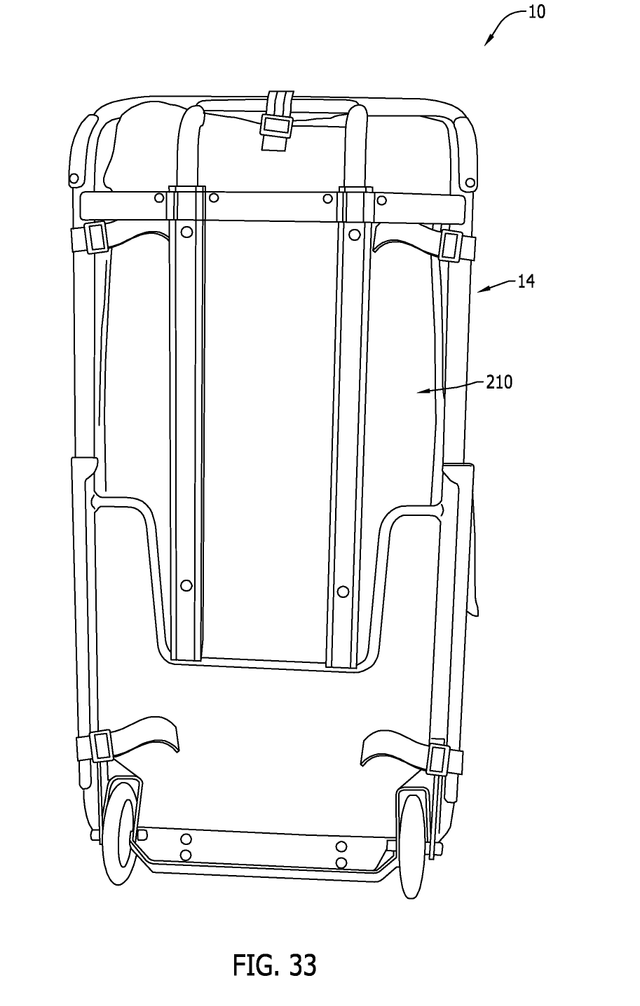

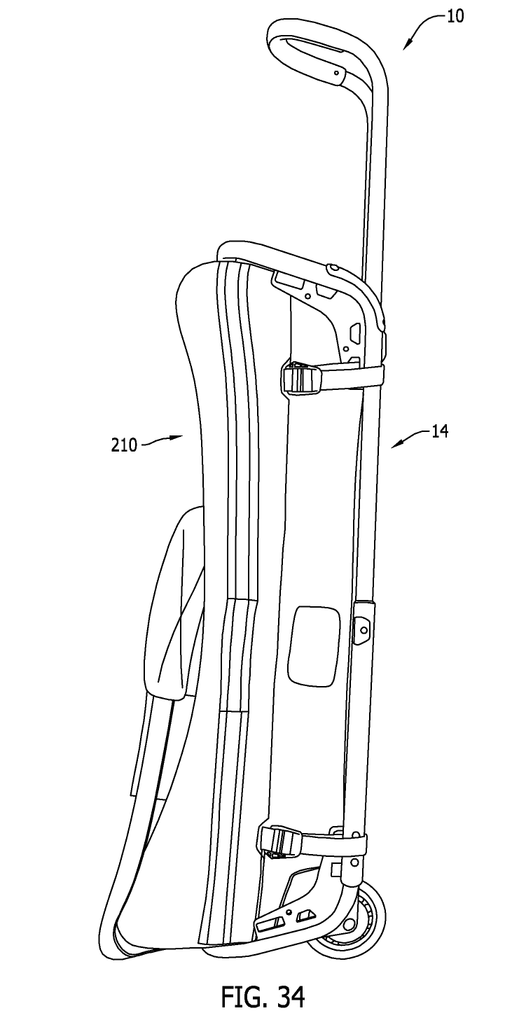

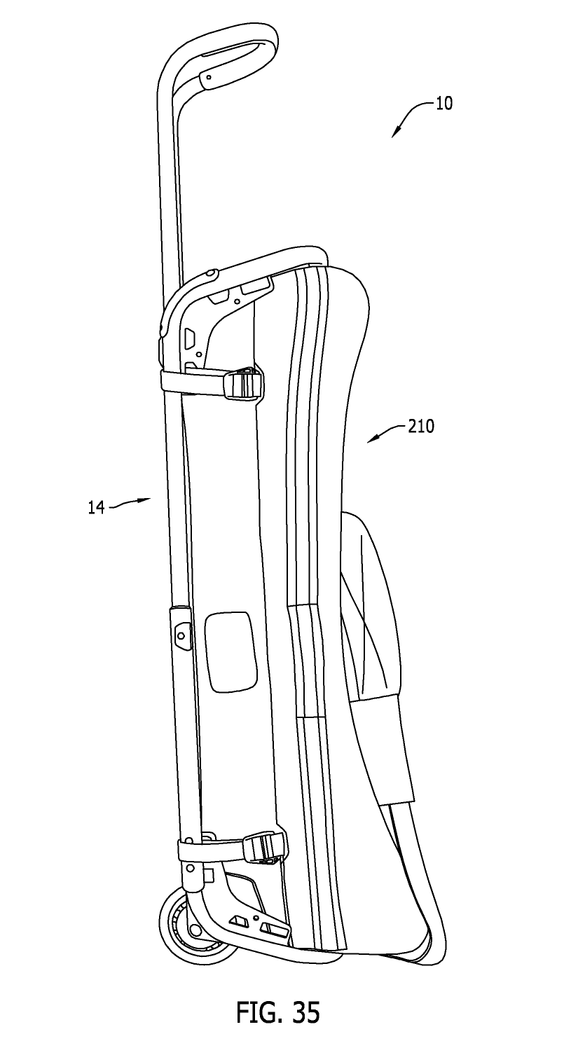

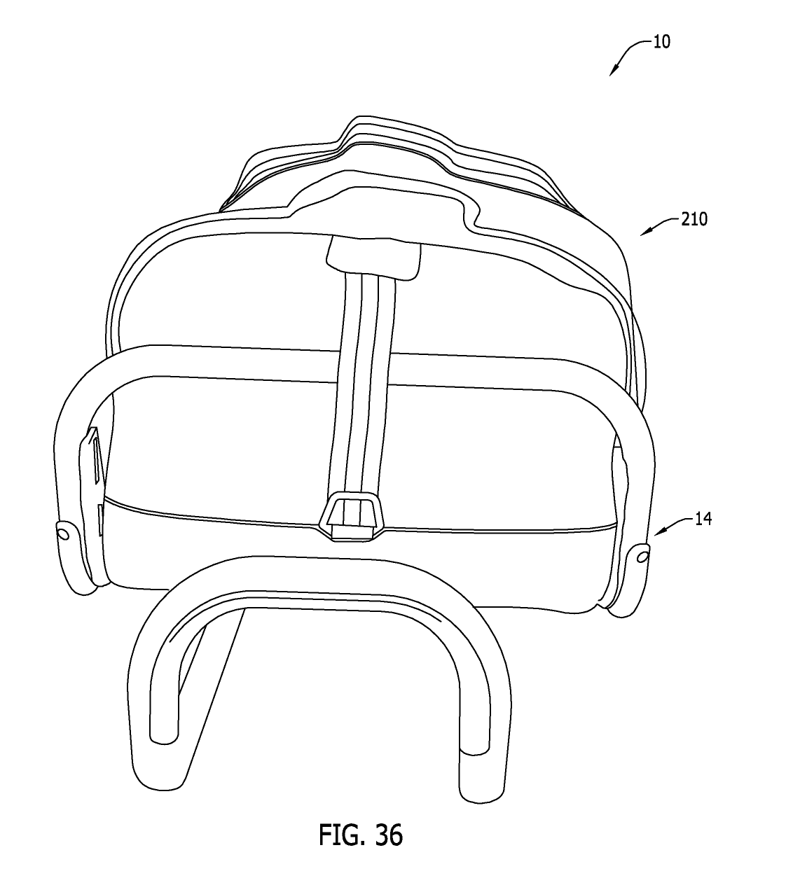

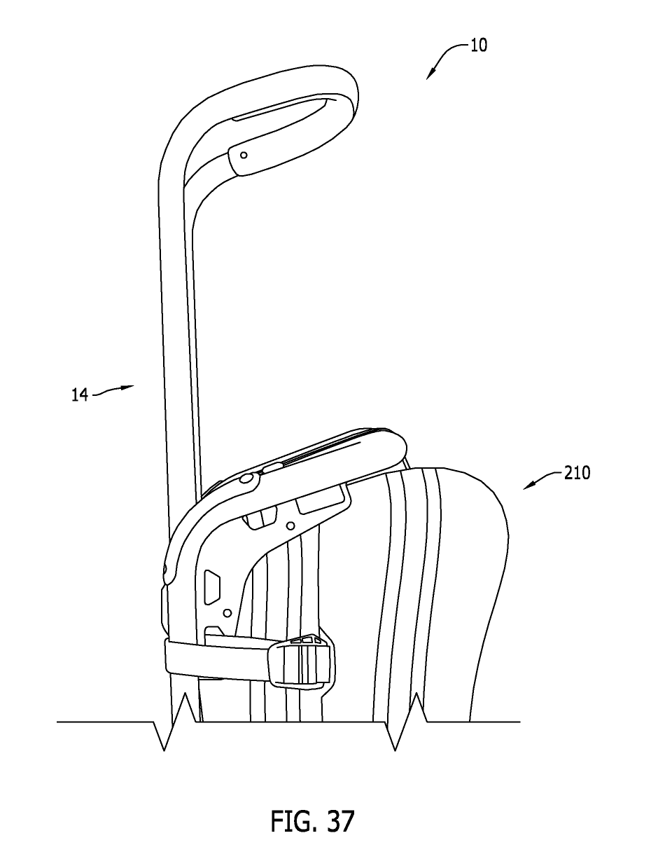

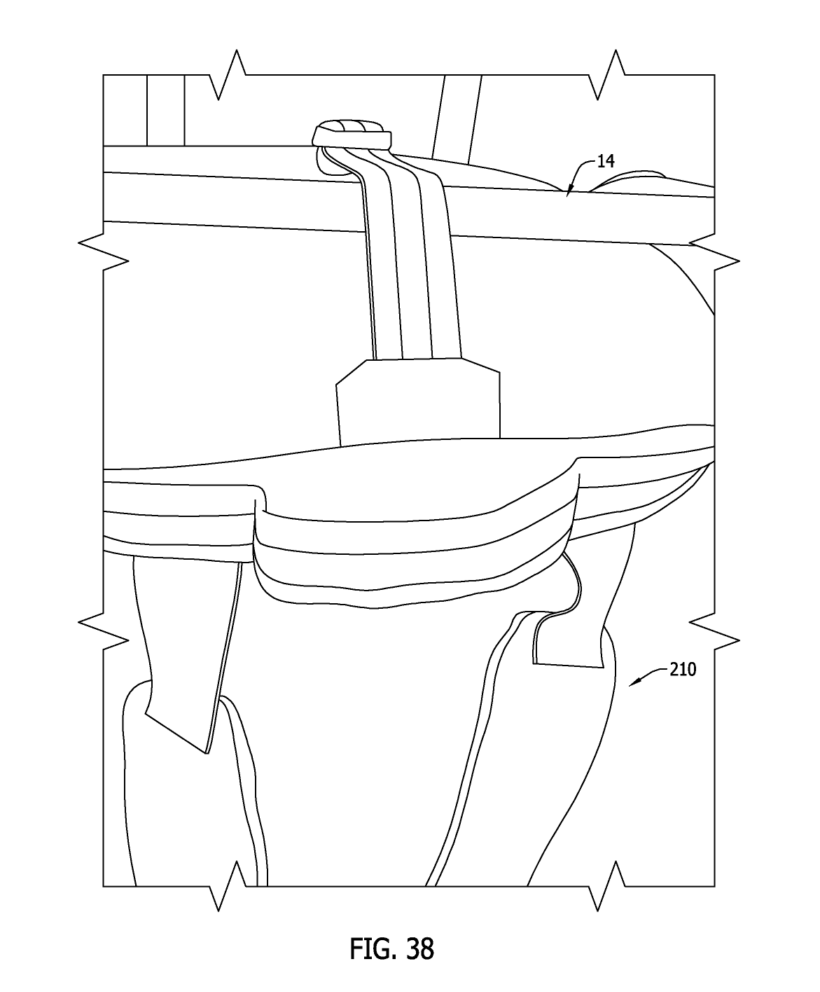

It is contemplated that the luggage can be other than the illustrated packbag 12. For example, FIGS. 24-31 illustrate the assembly 10 comprising a larger packbag, indicated generally at 110, attached to the cart 14, and FIGS. 32-38 illustrate the assembly 10 comprising yet another packbag, indicated generally at 210, attached to the cart. It is also contemplated that the luggage can be something besides a packbag such as, but not limited to, a computer bag, a brief case, duffle bag, a garment bag, a trunk, or a suitcase. It is further contemplated that cart 14 can be used with more than one piece of luggage. For example, FIG. 39 illustrates the cart 14 of the assembly 10 being used to transport the luggage seen FIGS. 1-16 and the luggage seen FIGS. 32-38 simultaneously. It is contemplated that the cart 14 can be used with a modular luggage system comprises multiple pieces of luggage wherein the pieces of luggage can be selectively attached and detected to each other. In such an embodiment, the convertible luggage and luggage cart assembly can be defined by the cart 14 in combination with one piece of the luggage (if the luggage of the luggage system is used separately) or in combination with multiple pieces of the luggage (if multiple pieces of the luggage system are attached together and used simultaneously).

This written description uses examples to disclose the invention, including the best mode, and also to enable a person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As various changes could be made in the above constructions and methods, without departing from the scope of the invention, it is intended that all matter contained in the above description and shown in the accompanying drawings shall be interpreted as illustrative and not in a limiting sense.

When introducing elements of the invention or the preferred aspect(s) thereof, the articles “a”, “an”, “the” and “said” are intended to mean that there are one or more of the elements. The terms “comprising”, “including” and “having” are intended to be inclusive and mean that there may be additional elements other than the listed elements.

The references to “top”, “bottom”, “upper” and “lower” are used for convenience in describing relative position of parts, and apply when the convertible luggage and luggage cart assembly 10 is in ordinary use as shown, for example, in FIG. 1. However, these and other positional terms used herein do not require the convertible luggage and luggage cart assembly 10 to be maintained in any particular orientation to fall within the scope of the invention.

What is claimed is:

1. A luggage and luggage cart assembly comprising:
a piece of luggage selectively moveable between a collapsed configuration and an expanded configuration, the luggage having a greater longitudinal length in the expanded configuration as compared to the collapsed configuration; and
a cart selectively moveable between a retracted position and an extended position, the cart, in the refracted position, being sized and arranged to carry the luggage in the collapsed configuration and, in the extended position, being sized and arranged to carry the luggage in the expanded configuration.

2. The luggage and luggage cart assembly set forth in claim 1 wherein the luggage includes a front, a back, a top, a bottom and two longitudinal sides, and the cart includes a frame adapted to protect at least the top, the back, and the bottom of the luggage when the luggage is secured to the frame.

3. The luggage and luggage cart assembly set forth in claim 2 wherein the frame comprises an upper portion, a lower portion, and a middle portion extending between and connecting the upper and lower portions.

4. The luggage and luggage cart assembly set forth in claim 3 wherein each of the upper and lower portions of the frame are angled relative to the middle portion at an angle greater than 90 degrees and less than 135 degrees.

5. The luggage and luggage cart assembly set forth in claim 3 wherein the middle portion of the frame is telescopic for moving the cart between the retracted position and the extended position.

6. The luggage and luggage cart assembly set forth in claim 5 wherein the middle portion of the frame includes a pair of spaced apart inner tubes slidingly received within a pair of spaced apart outer tubes, each of the outer tubes having a first aperture and a second aperture spaced from the first aperture, a pair of spring loaded stops being adapted to extend through the first and second apertures and thereby lock the cart in either the retracted position or the extended position.

7. The luggage and luggage cart assembly set forth in claim 1 wherein the cart includes a handle moveable between a stowed position and a use position.

8. A luggage and luggage cart assembly comprising a cart and a packbag selectively attachable and detachable from the cart, the packbag having a pair shoulder strap for carrying the packbag alone when the packbag is detached from the cart and the assembly when the packbag is attached to the cart in a generally vertical orientation.

9. The luggage and luggage cart assembly set forth in claim 8 wherein the packbag includes a front panel, a back panel, a top panel, a bottom panel, and two side panels, the shoulder strap being disposed on the front panel and the front panel being free of the cart.

10. The luggage and luggage cart assembly set forth in claim 8 wherein the packbag has a width, a thickness and a length, the packbag being selectively expandable in at least one of the thickness and the length.

11. The luggage and luggage cart assembly set forth in claim 8 wherein the packbag includes a pocket for stowing the shoulder straps.

12. The luggage and luggage cart assembly set forth in claim 8 wherein the cart includes a pair of wheels and the packbag includes a pair of wheel wells for receiving the wheels of the cart.

13. The luggage and luggage cart assembly set forth in claim 8 wherein the packbag includes at least one handle for carrying the packbag, if used without the cart, and the assembly, if the packbag is attached to the cart, in a generally horizontal orientation.

14. A luggage and luggage cart assembly comprising a cart and a piece of luggage selectively attachable and detectable from the cart, the luggage and cart being sized and configured to be carried onto an aircraft when the luggage is attached to the cart, the luggage and cart collectively having a maximum size less than or equal to 45 linear inches.

15. The luggage and luggage cart assembly as set forth in claim 14 wherein the luggage includes a first fastening member and the cart includes a second fastening member configured to selectively engage the first fastening member to thereby attach the luggage to the cart.

16. The luggage and luggage cart assembly as set forth in claim 15 wherein the first fastening member comprises a loop and the second fastening member comprises a buckle adapted to engage the loop.

17. The luggage and luggage cart assembly as set forth in claim 14 wherein the cart includes a retractable handle having a pair of downwardly extending tube members and a gripping portion disposed between and interconnecting the two tube members.

18. The luggage and luggage cart assembly as set forth in claim 17 wherein the cart includes a pair of tubular sleeves for receiving the tube members of the handle, each of the sleeves having a generally square cross-section and including a pair of longitudinally extending ridges and a channel extending between the ridges.

19. The luggage and luggage cart assembly as set forth in claim 14 wherein the cart includes a pair of wheels and a wheel mounting bar for mounting the wheels on the cart, the wheel mounting bar including a pair of generally U-shaped portions, two angled portions, and a generally straight portion extending between and connecting the angled portions, each of the U-shaped portion being configured to receive one of the wheels.

20. The luggage and luggage cart assembly as set forth in claim 14 wherein the luggage is selectively moveable between a collapsed configuration and an expanded configuration, the luggage having a greater longitudinal length in the expanded configuration as compared to the collapsed configuration, and the cart is selectively moveable between a refracted position and an extended position, the cart, in the retracted position, being sized and arranged to carry the luggage in the collapsed configuration and, in the extended position, being sized and arranged to carry the luggage in the expanded configuration, the maximum size being less than or equal to 45 linear inches being when the luggage is in the collapsed configuration and the cart is in the retracted position.

21. The luggage and luggage cart assembly as set forth in claim 15 wherein the luggage is a packbag.
